(19) United States
(12) Patent Application Publication
(10) Pub. No.: US 2024/0218224 A1
(43) Pub. Date: Jul. 4, 2024

(54) ABRASIVE ARTICLES AND METHODS OF FORMING SAME

(71) Applicants: SAINT-GOBAIN ABRASIVES, INC., Worcester, MA (US); SAINT-GOBAIN ABRASIFS, Conflans-Sainte_Honorine (FR)

(72) Inventors: Hua FAN, Southborough, MA (US); Anthony MARTONE, Belmont, MA (US); Yi-Tang KAO, Marlborough, MA (US); Kelley MCNEAL, Northborough, MA (US); Yinggang TIAN, Shrewsbury, MA (US)

(21) Appl. No.: 18/399,470

(22) Filed: Dec. 28, 2023

Related U.S. Application Data
(60) Provisional application No. 63/477,994, filed on Dec. 30, 2022.

(51) Int. Cl. C09K 3/14

(52) U.S. Cl. CPC C09K 3/1409

(57) ABSTRACT

According to one aspect, an abrasive article includes a backing; a make coat overlying the backing; an abrasive layer comprising abrasive particles and a binder; wherein the abrasive particles comprise a random rotational orientation; wherein the abrasive particles comprise a total height, H, and a fracture feature located at a height of 55%-90% H. The fracture feature is configured to enable fracturing when the particle has a front facing orientation relative to the grinding direction relative to the amount of fracturing when the particle is in a side facing orientation relative to the grinding direction.

### CROSS-REFERENCE TO RELATED APPLICATION(S)

This application claims priority under 35 U.S.C. § 119(e) to U.S. Provisional Patent Application No. 63/477,994, filed Dec. 30, 2022, by Hua FAN et al., entitled “ABRASIVE ARTICLES AND METHODS OF FORMING SAME,” which are both assigned to the current assignees hereof and incorporated herein by reference in their entireties.

### BACKGROUND

### Field of the Disclosure

The following is directed to abrasive articles, and, in particular, coated abrasive articles and methods of forming coated abrasive articles.

### SUMMARY

According to one aspect, an abrasive article includes a backing; a make coat overlying the backing; an abrasive layer comprising abrasive particles and a binder; wherein the abrasive particles comprise a random rotational orientation; wherein the abrasive particles comprise a total height, H, and a fracture feature located at a height of 55%-90% H. The fracture feature is configured to enable fracturing when the particle has a front facing orientation relative to the grinding direction relative to the amount of fracturing when the particle is in a side facing orientation relative to the grinding direction.

### BRIEF DESCRIPTION OF THE DRAWINGS

The present disclosure may be better understood, and its numerous features and advantages made apparent to those skilled in the art by referencing the accompanying drawings.

FIG. 1A includes an image of abrasive particles with different rotational orientations relative to a grinding direction.

FIG. 1B includes a plot comparing grinding energy vs. cumulative material removed for abrasive articles having particles in the different rotational orientations of FIG. 1A.

FIG. 2A includes a top-view illustration of a portion of a coated abrasive article according to an embodiment.

FIG. 2B includes a top-view illustration of a portion of a coated abrasive article according to an embodiment.

FIG. 3 includes an exemplary image of a portion of an abrasive article having abrasive particles in a random orientation.

FIG. 4A includes a side-view illustration of abrasive particles on a backing according to an embodiment.

FIG. 4B includes a side-view illustration of a particle on a backing having a tilt angle according to an embodiment.

FIG. 4C includes a top-down illustration of the particle of FIG. 4B.

FIG. 4D includes a side-view illustration of a particle on a backing having a tilt angle according to an embodiment.

FIG. 4E includes a top-down illustration of the particle of FIG. 4D.

FIG. 5A includes a perspective view illustration of a shaped abrasive particle according to an embodiment.

FIG. 5B includes a top-down view illustration of a shaped abrasive particle according to an embodiment.

FIG. 6A includes an image of a 3-PT star-shaped abrasive particle.

FIG. 6B includes an illustration of a side view of the shaped abrasive particle of FIG. 65A.

FIG. 7 includes a perspective view illustration of a shaped abrasive particle according to an embodiment.

FIG. 8A includes a perspective view illustration of a controlled height abrasive particle according to an embodiment.

FIG. 8B includes a perspective view illustration of a non-shaped particle according to an embodiment.

FIG. 9 includes an illustration of an indentation radius of curvature of an abrasive particle according to an embodiment.

FIG. 10 includes a perspective view illustration of a 3-PT star-shaped abrasive particle having fracture features as described herein.

FIGS. 11A-G include images of modeled abrasive particles.

FIGS. 12A-G include images of stresses of modeled abrasive particles.

FIGS. 13A-G include images of stresses of modeled abrasive particles.

FIG. 14 includes an illustration of a radius of curvature of Samples S5 and S6.

### DETAILED DESCRIPTION

The following is directed to methods of forming abrasive articles, such as fixed abrasive articles, and more particularly, coated abrasive articles. The abrasive articles may be used in a variety of material removal operations for a variety of work pieces.

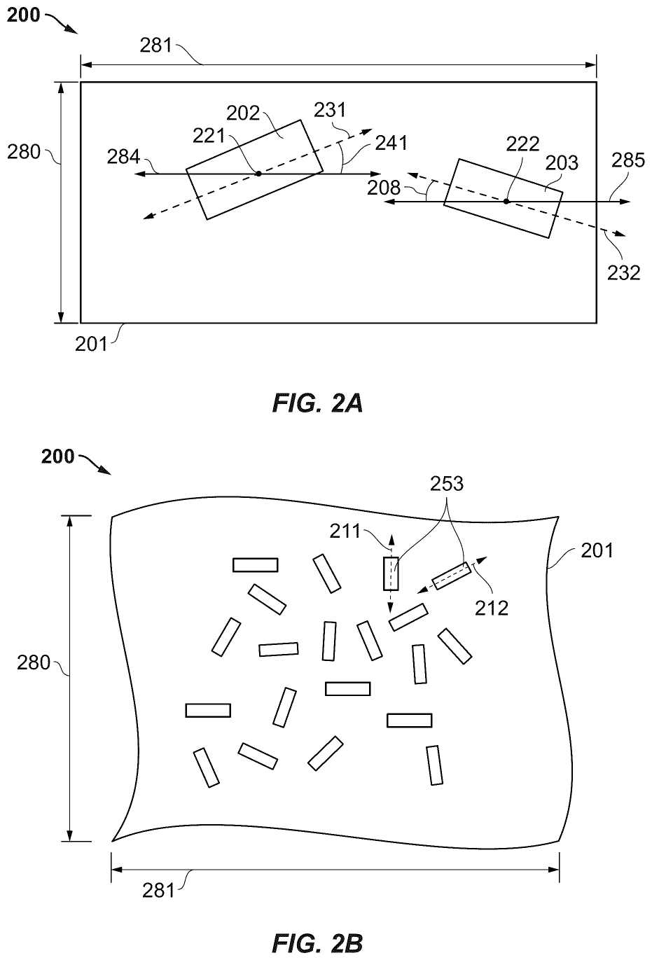

FIG. 2A includes an illustration of a portion of a coated abrasive article 200 according to an embodiment. As shown in FIG. 2, the coated abrasive article 200 can include a backing 201 having a longitudinal axis 280 defining a grinding direction and a lateral axis 281. The abrasive article 200 can include a backing 201 having a major surface and an abrasive layer forming an abrasive surface overlying the major surface of the backing. The abrasive layer can form a single layer of abrasive particles 202 and 203 adhered via a binder to the major surface of the backing. FIG. 2B also includes an illustration of a portion of a coated abrasive with abrasive particles 202 and 203.

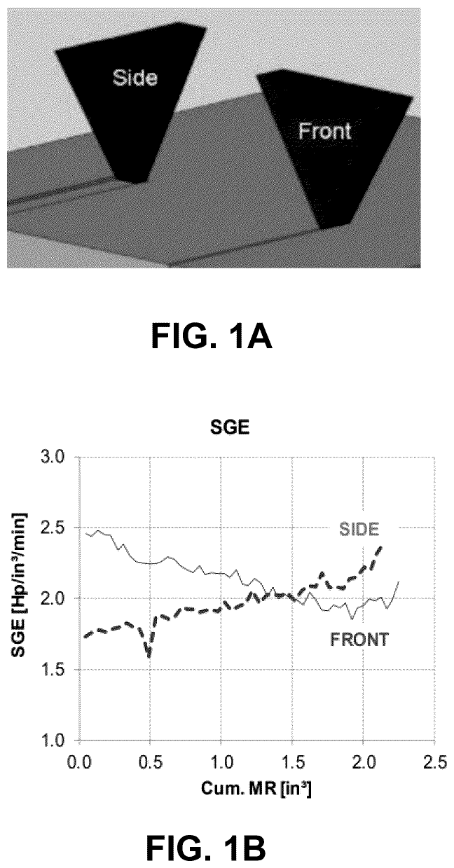

The orientation of particles is known to have an impact on fracturing behavior and performance of abrasive particles. Referring to FIG. 1, the grinding behavior of particles with a front facing orientation relative to the grinding direction is different than particles with a side facing orientation. Grinding energy decreases over time as front facing particles fracture and wear. For side facing particles, the opposite occurs; grinding energy increases as the particles fracture and wear. Accordingly, particles that fracture while used in a front facing orientation but do not fracture while in a side orientation are desirable. Such particles can be placed and provide benefit regardless of rotational orientation relative to the grinding direction.

In an embodiment, the abrasive particles may have a random rotational orientation relative to the grinding direction. The randomness of the rotational orientation is evaluated by creating a histogram or distribution of measured orientations from randomly sampled areas from a given abrasive article. The process for measuring the rotational orientation of particles on a substrate is started by obtaining a coated abrasive sample that does not include overlying layers on the particles or cleaning the coated abrasive sample to expose the particles, such that the particles are clearly visible. If a coated abrasive article includes layers overlying the particles (e.g., size coat, supersize coat, etc.) a gentle sandblasting operation can be conducted to selectively remove the overlying layers and expose the underlying abrasive particles. Care should be taken during the sandblasting operation to ensure that the particles are not damaged or moved. The selective removal operation may be conducted in stages to ensure that only the overlying layers are removed but the underlying particles are not damaged or altered.

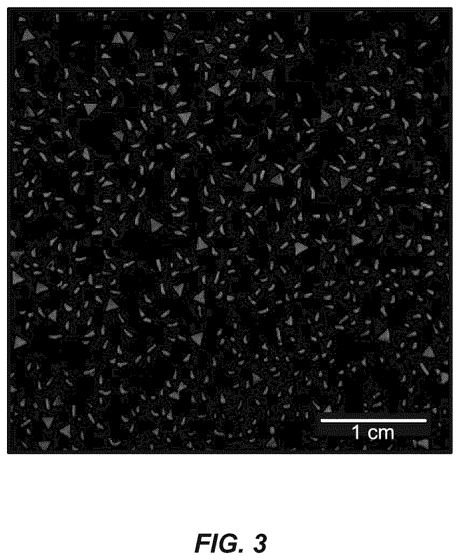

After obtaining a sample with the particles exposed, at least two randomly selected regions of the sample are imaged using a suitable device, such as a Canon Powershot S110 camera with a resolution of 338 pixels/cm. From these images, the location and orientation of each particle relative to the edge of the sample are cataloged using MATLAB image analysis software. The orientation of the particle is based on intended grinding direction of the abrasive article. The same axis should be used to evaluate all sample images. The orientation of each particle is defined by an orientation angle between −90 degrees and +90 degrees. The orientation angles are then plotted in a plot of orientation angle (x-axis) versus frequency (y-axis) to create a histogram of the orientation angles. If the histogram has an essentially flat profile, such that the frequency for any given orientation angle is nearly the same as the frequency for any other orientation angle, the histogram demonstrates that the particles generally have no primary orientation mode, and therefore, the particles have a random orientation. FIG. 3 includes an exemplary image of a portion of an abrasive article having abrasive particles in a random orientation.

It should be noted that while certain embodiments herein can have particles arranged in a random orientation, other embodiments may include particles arranged in a non-random or controlled distribution.

According to one embodiment, an abrasive particle 202 can be overlying the backing 201 in a first position having a first rotational orientation relative to a lateral axis 281 defining the width of the backing 201 and perpendicular to a longitudinal axis 280 defining the intended grinding direction. In particular, the abrasive particle 202 can have a rotational orientation defined by a first rotational angle between a lateral axis 284 perpendicular to the intended grinding direction and a dimension of the abrasive particle 202. Notably, reference herein to a dimension can be a reference to a bisecting axis 231 of the abrasive particle 202 extending through a center point 221 of the abrasive particle 202 as viewed top-down. Moreover, the predetermined rotational orientation can be defined as the smallest angle 241 with the lateral axis 284 extending through the center point 221. As illustrated in FIG. 2A, the abrasive particle 202 can have a predetermined rotational angle defined as the smallest angle 241 between the bisecting axis 231 and the lateral axis 284, wherein the lateral axis is parallel to the lateral axis 281. It will be appreciated that the lateral axis 281 may also be a radial axis where the backing 201 has a circular or elliptical shape. In accordance with an embodiment, the angle 241 defining the rotational orientation of the abrasive particle 202 relative to the lateral axis 284 can be any value within a range between at least 0 degrees and not greater than 90 degrees.

As further illustrated in FIG. 2A, the abrasive particle 203 can be at a second position overlying the backing 201 and having a rotational orientation. Notably, the rotational orientation of the abrasive particle 203 can be characterized as the smallest angle between the lateral axis 285 perpendicular to the grinding direction and a bisecting axis 232 of the abrasive particle 203 extending through a center point 222 of the abrasive particle 203. In accordance with an embodiment, the rotational angle 208 can be any value within a range of at least 0 degrees to 90 degrees. A particle with a front facing orientation has a rotational angle of 0-45, while a particle with a side facing orientation has a rotational angle of 45-90. Exemplary particles in front and side orientations can be found in FIG. 1A.

FIG. 2B includes a top-view illustration of a portion of a coated abrasive article according to an embodiment. As illustrated, the abrasive article 200 can include a plurality of abrasive particles arranged at different positions on the backing 201, wherein the abrasive particles 253 define a random distribution of the particles on the backing. Moreover, the abrasive particles 253 have a random rotational orientation with respect to each other, such that the rotational orientation of the abrasive particles 253 varies from particle-to-particle in a random manner. According to one aspect, the random rotational orientation of the abrasive particles is such that the rotational angle of one abrasive particle in the group cannot be used to predict the rotational orientation of any of the immediately adjacent particles. Thus, a group of abrasive particles having a random rotational orientation lacks any short-range (i.e., immediately adjacent) or long-range order with respect to their rotational angles. It will be appreciated that any particles attached to the backing using the systems and processes of the embodiments herein can have a random rotational orientation with respect to each other.

The coated abrasive articles of the embodiments herein can have at least a majority of the total content (weight or number) of abrasive particles having a random rotational orientation on the backing. In still other instances, at least 10% of the total number of shaped abrasive particles or at least 20%, or at least 30%, or at least 40%, or at least 50%, or at least 60%, or at least 70%, or at least 80%, or at least 90%, or essentially all of the shaped abrasive particles have a random rotational orientation. In one embodiment, all of the abrasive particles on the backing have a random rotational orientation.

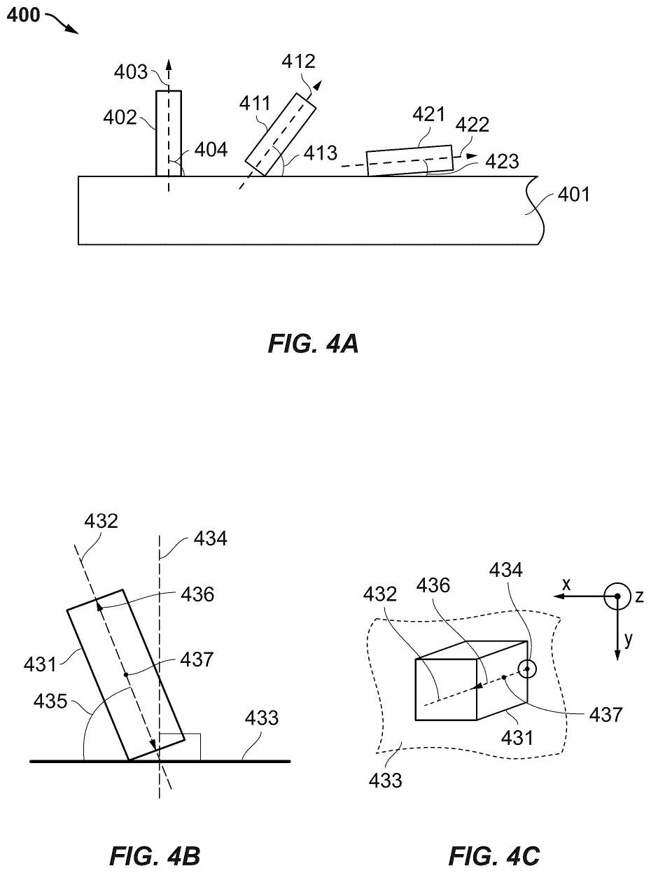

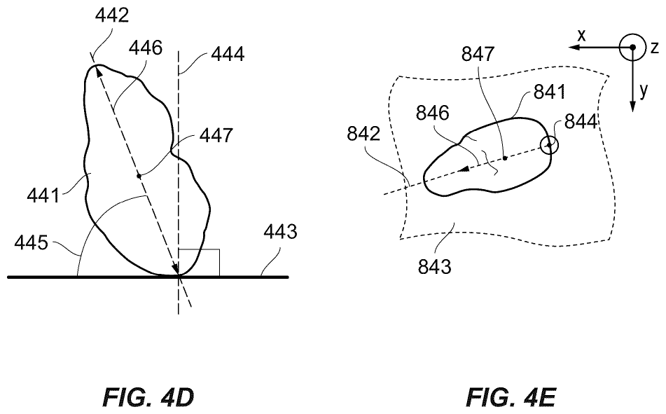

FIG. 4A includes a side-view illustration of abrasive particles on a backing according to an embodiment. The methods disclosed in the embodiments herein can facilitate the formation of coated abrasive articles having a particular distribution and orientation of abrasive particles. Notably, without wishing to be tied to a particular theory, it is noted that the projection rate and efficiency of the process disclosed herein may facilitate improved control of the tilt angle of the abrasive particles adhered to the backing. To better understand these features, FIG. 4A provides a side-view illustration of three abrasive particles in various orientations. It will be appreciated that the coated abrasive articles of the embodiments herein can have various contents of particles in the depicted orientations as described in more detail herein. The first particle 402 can have a particle axis 403 extending at a particular tilt angle 404 relative to the surface of the backing 401. The particle axis 403 can be parallel to the longitudinal axis of the first particle 402 that defines the length of the first particle 402. The first particle 402 is representative of a particle in a standing orientation having a tilt angle 404 within a range of greater than 65 degrees to 90 degrees. The second particle 411 can have a particle axis 412 extending at a particular tilt angle 413 relative to the surface of the backing 401. The particle axis 412 can be parallel to a longitudinal axis of the second particle 411 that defines the length of the second particle 411. The second particle 411 is representative of a particle in a slanted orientation having a tilt angle 413 within a range of greater than 5 degrees to 65 degrees. The third particle 421 can have a particle axis 422 extending at a particular tilt angle 423 relative to the surface of the backing 401. The particle axis 422 can be parallel to a longitudinal axis of the third particle 421 that defines the length of the third particle 421. The third particle 421 is representative of a particle in a flat orientation having a tilt angle 423 within a range of 0 degrees to not greater than 5 degrees (i.e., not greater than 5 degrees). FIG. 4B includes a side-view illustration of a particle on a backing having a particular tilt angle according to an embodiment. As illustrated, the particle 431 can be a shaped abrasive particle as described in embodiments herein. The particle 431 can have a longitudinal axis 436 as defined later in this application. The backing 433 can define a substantially planar surface and have an axis 434 extending normally to the substantially planar surface of the backing 433. The tilt angle 435 is the smallest angle between the planar surface of the backing 433 and an axis 432, which extends parallel to the longitudinal axis 436 of the particle 431. Certain particles can have longitudinal axes along various surfaces, which may result in different tilt angles. In such instances, the axis defining the largest angle is the tilt angle.

FIG. 4C includes a top-down illustration of the particle of FIG. 4B. In certain instances, a top-down view may provide a suitable vantage for identifying the direction of the tilt and thus can be suitable for measuring the tilt angle.

FIG. 4D includes a side-view illustration of a particle on a backing having a particular tilt angle according to an embodiment. As illustrated, the particle 441 can have a longitudinal axis 446 as defined later in this application. The particle 441 can be an abrasive particle, and more particularly, can be a non-shaped abrasive particle. The backing 443 can define a substantially planar surface and have an axis 444 extending normally to the substantially planar surface of the backing 443. The tilt angle 445 can be the smallest angle between an axis 442, which extends parallel to the longitudinal axis 446 and the surface of the backing 443. It will be appreciated that certain particles, such as equiaxed particles, will not have a tilt angle.

FIG. 4E includes a top-down illustration of the particle of FIG. 4D. The top-down view may be used to evaluate the tilt angle of the particle. As depicted, the top-down view may be the best view for evaluating the tilt angle as a side-view may not necessarily ensure the smallest angle is identified. A combination of top-down and side-view illustrations may be suitable for identifying and evaluating the tilt angle 445.

In one aspect, a coated abrasive article may include a plurality of abrasive particles, wherein the tilt angle of the abrasive particles is controlled, which may facilitate improved performance of the coated abrasive. For example, at least a portion of the shaped abrasive particles have a tilt angle greater than 45 degrees. In further aspects, a portion includes at least 10% of the total number of shaped abrasive particles or at least 20%, or at least 30%, or at least 40%, or at least 50%, or at least 60%, or at least 70%, or at least 80%, or at least 90%, or essentially all the shaped abrasive particles have a tilt angle greater than 45 degrees.

In an embodiment, the coated abrasive article may have a particular percentage of standing particles that may facilitate improved performance and/or manufacturing of the abrasive article. Standing particles can be defined as particles having a tilt angle of 65 to 90 degrees. In an embodiment, the standing abrasive particles can include at least 10% of the total number of the abrasive particles or at least 20%, or at least 30%, or at least 40%, or at least 50%, or at least 55%, or at least 57%, or at least 60%, or at least 62%, or at least 65%, or at least 67%, or at least 70%, or at least 72%, or at least 75%, or at least 77%, or at least 80%, or at least 82%, or at least 85%, or at least 87%, or at least 90% of the total number of the abrasive particles. In another embodiment, the standing abrasive particles can include not greater than 99.9% of the total number of the abrasive particles or not greater than 99%, or not greater than 98%, or not greater than 97%, or not greater than 96%, or not greater than 95% of the total number of the abrasive particles. It will be appreciated that the percentage of standing particles can be between any of the minimum and maximum values noted above, including, for example, but not limited to, at least 20% and not greater than 99%, or at least 50% and not greater than 95%.

In an embodiment, the coated abrasive article may have a particular percentage of slanted particles that may facilitate improved performance and/or manufacturing of the abrasive article. Slanted particles can be defined as particles having a tilt angle of 5 to 65 degrees. In an embodiment, the slanted abrasive particles can include at least 1% of the total number of the abrasive particles or at least 2%, or at least 3%, or at least 4%, or at least 5%, or at least 6%, or at least 7%, or at least 8%, or at least 9%, or at least 10%, or at least 11%, or at least 12%, or at least 13%, or at least 14%, or at least 15%, or at least 16%, or at least 17%, or at least 18%, or at least 20%, or at least 25% of the total number of the abrasive particles. In another embodiment, the slanted abrasive particles can include not greater than 90% of the total number of the abrasive particles or not greater than 85%, or not greater than 80%, or not greater than 75%, or not greater than 70%, or not greater than 65%, or not greater than 60%, or not greater than 55%, or not greater than 50%, or not greater than 45%, or not greater than 40%, or not greater than 35%, or not greater than 30%, or not greater than 25%, or not greater than 20%, or not greater than 18%, or not greater than 15%, or not greater than 12%, or not greater than 10% of the total number of the abrasive particles. It will be appreciated that the percentage of slanted particles can be between any of the minimum and maximum values noted above, including, for example, but not limited to, at least 5% and not greater than 80%, or at least 15% and not greater than 35%.

In an embodiment, the coated abrasive article may have a particular percentage of well oriented particles that may facilitate improved performance and/or manufacturing of the abrasive article. Well oriented particles can be defined as particles having a tilt angle of 5 to 90 degrees and include slanted and standing particles. In an embodiment, the well oriented abrasive particles can include at least 60% of the total number of the abrasive particles or at least 62%, or at least 65%, or at least 67%, or at least 70%, or at least 72%, or at least 75%, or at least 77%, or at least 80%, or at least 82%, or at least 85%, or at least 87%, or at least 90%, or at least 92%, or at least 95% of the total number of the abrasive particles. In another embodiment, the well oriented abrasive particles can be not greater than 99.9% of the total number of the abrasive particles or not greater than 99%, or not greater than 98%, or not greater than 97%, or not greater than 96%, or not greater than 95%. It will be appreciated that the percentage of well oriented particles can be between any of the minimum and maximum values noted above, including, for example, but not limited to, at least 5% and not greater than 80%, or at least 15% and not greater than 35%.

In an embodiment, the coated abrasive article may have a particular percentage of fallen particles that may facilitate improved performance and/or manufacturing of the abrasive article. Fallen particles can be defined as particles having a tilt angle of 0 to 5 degrees. In an embodiment, the fallen abrasive particles at least 0.1% of the total number of the abrasive particles or at least 0.2%, or at least 0.4%, or at least 0.6%, or at least 0.8%, or at least 1%, or at least 1.5%, or at least 2%, or at least 2.5%, or at least 3%, or at least 3.5%, or at least 4%, or at least 4.5%, or at least 5% of the total number of the abrasive particles. In another embodiment, the fallen abrasive particles can include not greater than 20% of the total number of the abrasive particles or not greater than 18%, or not greater than 15%, or not greater than 12%, or not greater than 10%, or not greater than 9%, or not greater than 8%, or not greater than 7%, or not greater than 6%, or not greater than 5% of the total number of the abrasive particles. It will be appreciated that the percentage of fallen particles can be between any of the minimum and maximum values noted above, including, for example, but not limited to, at least 0.2% and not greater than 15%, or at least 1% and not greater than 9%.

In an embodiment, the coated abrasive article may have a particular percentage of inverted particles that may facilitate improved performance and/or manufacturing of the abrasive article. Inverted particles can be defined as particles having a tilt angle of 5 to 90 degrees as well as having a tip, corner, or point extending into the make coat, and a planar surface or surfaces such as a base, opposite the tip on the other end of the abrasive particle. Only particles having a tip on one end of its longitudinal axis and at least one planar surface on the opposite end of the longitudinal axis can be inverted. Exemplary particle shapes that can be in an inverted orientation include triangles, 3-PT (3-PT) stars, pentagons, and pyramids. Particles having planar surfaces on both ends of their longitudinal axis (e.g., rods or cylinders, rectangular prisms,) and particles having points on both ends of their longitudinal axis [e.g., toothpick-shaped, diamond-shaped, 4-pointed (4-PT) stars] cannot be in an inverted orientation. Inverted particles are not standing, slanted, fallen, or well oriented. In an embodiment, the inverted abrasive particles make up at least 0.1% of the total number of the abrasive particles or at least 0.2%, or at least 0.4%, or at least 0.6%, or at least 0.8%, or at least 1%, or at least 1.5%, or at least 2%, or at least 2.5%, or at least 3%, or at least 3.5%, or at least 4%, or at least 4.5%, or at least 5% of the total number of the abrasive particles. In another embodiment, the inverted abrasive particles can include not greater than 20% of the total number of the abrasive particles or not greater than 18%, or not greater than 15%, or not greater than 12%, or not greater than 10%, or not greater than 9%, or not greater than 8%, or not greater than 7%, or not greater than 6%, or not greater than 5% of the total number of the abrasive particles. It will be appreciated that the percentage of inverted particles can be between any of the minimum and maximum values noted above, including, for example, but not limited to, at least 0.2% and not greater than 15%, or at least 1% and not greater than 9%.

In an embodiment, the coated abrasive particle may have a particular ratio (Pst/Psl) of standing particles (Pst) to slanted particles (Psl) that may facilitate improved performance and/or manufacturing of the abrasive article. In an embodiment, Pst/Psl can be at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6. In another embodiment, Pst/Psl can be not greater than 100, or not greater than 95, or not greater than 90, or not greater than 80, or not greater than 70, or not greater than 60, or not greater than 50, or not greater than 40, or not greater than 30, or not greater than 20, or not greater than 10. It will be appreciated that Pst/Psl can be between any of the minimum and maximum values noted above, including, for example, but not limited to, at least 1.2 and not greater than 95, or at least 2.0 and not greater than 40.

In an embodiment, the coated abrasive particle may have a particular ratio (Pst/Pf) of standing particles (Pst) to fallen particles (Pf) that may facilitate improved performance and/or manufacturing of the abrasive article. In an embodiment, Pst/Pf can be at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6, or at least 5.8, or at least 6.0, or at least 6.2, or at least 6.4, or at least 6.6, or at least 6.8, or at least 7.0, or at least 7.2, or at least 7.4, or at least 7.6, or at least 7.8, or at least 8.0. In another embodiment, Pst/Pf can be not greater than 1000, or not greater than 800, or not greater than 500, or not greater than 200, or not greater than 100, or not greater than 95. It will be appreciated that Pst/Pf can be between any of the minimum and maximum values noted above, including, for example, but not limited to, at least 2.0 and not greater than 500, or at least 2.6 and not greater than 95.

In an embodiment, the coated abrasive particle may have a particular ratio (Psl/Pf) of slanted particles (Psl) to fallen particles (Pf) that may facilitate improved performance and/or manufacturing of the abrasive article. In an embodiment, Psl/Pf can be at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6. In another embodiment, Psl/Pf can be not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6. It will be appreciated that Psl/Pf can be between any of the minimum and maximum values noted above, including, for example, but not limited to, at least 2.0 and not greater than 95, or at least 2.6 and not greater than 70.

In an embodiment, the coated abrasive particle may have a particular ratio (Pst/Pi) of standing particles (Pst) to inverted particles (Pi) that may facilitate improved performance and/or manufacturing of the abrasive article. In an embodiment, Pst/Pi can be at least 1, or at least 2.0, or at least 3.0, or at least 4.0, or at least 5.0, or at least 6, or at least 7, or at least 8, or at least 9, or at least 10, or at least 12, or at least 15, or at least 18, or at least 20, or at least 25, or at least 30, or at least 40, or at least 50. In another embodiment, Pst/Pi can be not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6. It will be appreciated that Pst/Pi can be between any of the minimum and maximum values noted above, including, for example, but not limited to, at least 2.0 and not greater than 80, or at least 6 and not greater than 20.

In an embodiment, the coated abrasive particle may have a particular ratio (Psl/Pi) of slanted particles (Psl) to inverted particles (Pi) that may facilitate improved performance and/or manufacturing of the abrasive article. In an embodiment, Psl/Pi can be at least 0.6, or at least 0.7, or at least 0.8, or at least 0.9, or at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6. In another embodiment, Psl/Pi can be not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6, or not greater than 4, or not greater than 3, or not greater than 2, or not greater than 1.5. It will be appreciated that Psl/Pi can be between any of the minimum and maximum values noted above, including, for example, but not limited to, at least 2.0 and not greater than 95, or at least 2.6 and not greater than 70.

In an embodiment, the coated abrasive particle may have a particular ratio (Pf/Pi) of fallen particles (Pf) to inverted particles (Pi) that may facilitate improved performance and/or manufacturing of the abrasive article. In an embodiment, Pf/Pi can be at least 0.6, or at least 0.7, or at least 0.8, or at least 0.9, or at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0. In another embodiment, Pf/Pi can be not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6, or not greater than 4, or not greater than 3, or not greater than 2, or not greater than 1.5. It will be appreciated that Pf/Pi can be between any of the minimum and maximum values noted above, including, for example, but not limited to, at least 2.0 and not greater than 95, or at least 2.6 and not greater than 70.

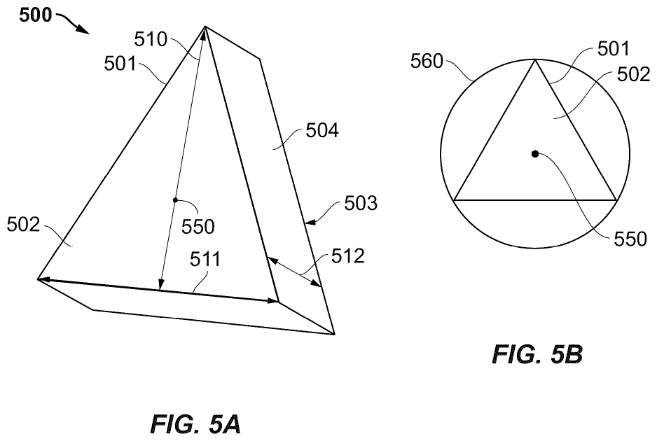

Embodiments herein have referred to particles, which can include abrasive particles, secondary particles, or any combination thereof. Various types of abrasive particles and/or secondary particles can be used with abrasive articles described in the embodiments herein. FIG. 5A includes a perspective view illustration of a shaped abrasive particle in accordance with an embodiment. The shaped abrasive particle 500 can include a body 501 including a major surface 502, a major surface 503, and a side surface 504 extending between the major surfaces 502 and 503. As illustrated in FIG. 5A, the body 501 of the shaped abrasive particle 500 can be a thin-shaped body, wherein the major surfaces 502 and 503 are larger than the side surface 504. Moreover, the body 501 can include a longitudinal axis 510 extending from a point to a base and through the midpoint 550 on a major surface 502, or 503. The longitudinal axis 510 can define the longest dimension of the body along a major surface and through the midpoint 550 of the major surface 502.

In certain particles, if the midpoint of a major surface of the body is not readily apparent, one may view the major surface top-down, draw a closest-fit circle around the two-dimensional shape of the major surface and use the center of the circle as the midpoint of the major surface. FIG. 5B includes a top-down illustration of the shaped abrasive particle of FIG. 5A. Notably, the body 501 includes a major surface 502 having a triangular two-dimensional shape. The circle 560 is drawn around the triangular shape to facilitate the location of the midpoint 550 on the major surface 502.

Referring again to FIG. 5A, the body 501 can further include a lateral axis 511 defining a width of the body 501 extending generally perpendicular to the longitudinal axis 510 on the same major surface 502. Finally, as illustrated, the body 501 can include a vertical axis 512, which in the context of thin-shaped bodies can define a height (or thickness) of the body 501. For thin-shaped bodies, the length of the longitudinal axis 510 is greater than the vertical axis 512. As illustrated, the thickness 512 can extend along the side surface 504 between the major surfaces 502 and 503 and perpendicular to the plane defined by the longitudinal axis 510 and lateral axis 511. It will be appreciated that reference herein to length, width, and height of the abrasive particles may be a reference to average values taken from a suitable sampling size of abrasive particles of a larger group, including, for example, a group of abrasive particles affixed to a fixed abrasive.

FIG. 5A includes an illustration of a shaped abrasive particle having a two-dimensional shape as defined by the plane of the upper major surface 502, or major surface 503, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, regular polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

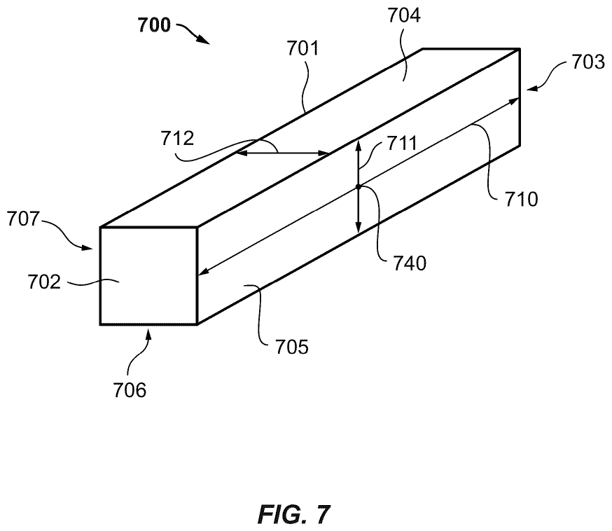

FIG. 7 includes a perspective view illustration of a shaped abrasive particle according to another embodiment. Notably, the shaped abrasive particle 700 can include a body 701 including a surface 702 and a surface 703, which may be referred to as end surfaces 702 and 703. The body can further include major surfaces 704, 705, 706, 707 extending between and coupled to the end surfaces 702 and 703. The shaped abrasive particle of FIG. 7 is an elongated shaped abrasive particle having a longitudinal axis 710 that extends along the major surface 705 and through the midpoint 740 between the end surfaces 702 and 703. For particles having an identifiable two-dimensional shape, such as the shaped abrasive particles of FIGS. 5 and 7, the longitudinal axis is the dimension that would be readily understood to define the length of the body through the midpoint on a major surface. For example, in FIG. 7, the longitudinal axis 710 of the shaped abrasive particle 700 extends between the end surfaces 702 and 703 parallel to the edges defining the major surface as shown. Such a longitudinal axis is consistent with how one would define the length of a rod. Notably, the longitudinal axis 710 does not extend diagonally between the corners joining the end surfaces 702 and 703 and the edges defining the major surface 705, even though such a line may define the dimension of greatest length. To the extent that a major surface has undulations or minor imperfections from a perfectly planar surface, the longitudinal axis can be determined using a top-down, two-dimensional image that ignores the undulations.

It will be appreciated that the surface 705 is selected for illustrating the longitudinal axis 710 because the body 701 has a generally square cross-sectional contour as defined by the end surfaces 702 and 703. As such, the surfaces 704, 705, 706, and 707 can be approximately the same size relative to each other. However, in the context of other elongated abrasive particles, the surfaces 702 and 703 can have a different shape, for example, a rectangular shape, and as such, at least one of the surfaces 704, 705, 706, and 707 may be larger relative to the others. In such instances, the largest surface can define the major surface and the longitudinal axis would extend along the largest of those surfaces through the midpoint 740 and may extend parallel to the edges defining the major surface. As further illustrated, the body 701 can include a lateral axis 711 extending perpendicular to the longitudinal axis 710 within the same plane defined by the surface 705. As further illustrated, the body 701 can further include a vertical axis 712 defining a height of the abrasive particle, wherein the vertical axis 712 extends in a direction perpendicular to the plane defined by the longitudinal axis 710 and lateral axis 711 of the surface 705.

It will be appreciated that like the thin-shaped abrasive particle of FIG. 5, the elongated shaped abrasive particle of FIG. 7 can have various two-dimensional shapes, such as those defined with respect to the shaped abrasive particle of FIG. 5. The two-dimensional shape of the body 701 can be defined by the shape of the perimeter of the end surfaces 702 and 703. The elongated shaped abrasive particle 700 can have any of the attributes of the shaped abrasive particles of the embodiments herein.

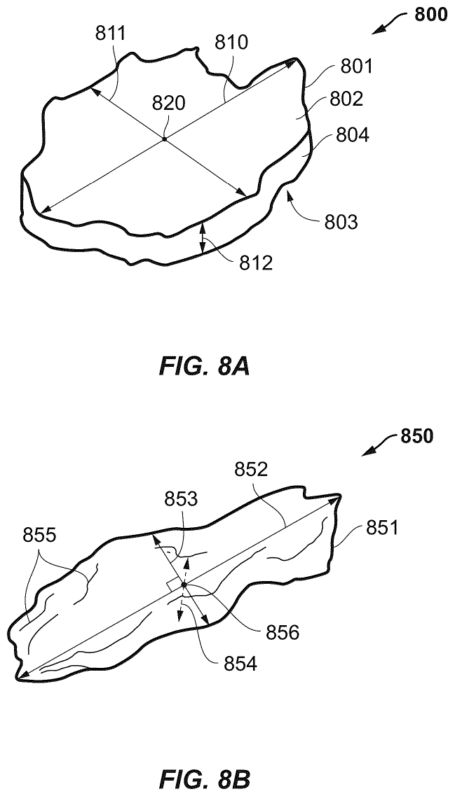

FIG. 8A includes a perspective view illustration of a controlled height abrasive particle according (CHAP) to an embodiment. As illustrated, the CHAP 800 can include a body 801 including a first major surface 802, a second major surface 803, and a side surface 804 extending between the first and second major surfaces 802 and 803. As illustrated in FIG. 8A, the body 801 can have a thin, relatively planar shape, wherein the first and second major surfaces 802 and 803 are larger than the side surface 804 and substantially parallel to each other. Moreover, the body 801 can include a longitudinal axis 810 extending through the midpoint 820 and defining a length of the body 801. The body 801 can further include a lateral axis 811 on the first major surface 802, which extends through the midpoint 820 of the first major surface 802, perpendicular to the longitudinal axis 810, and defining a width of the body 801.

The body 801 can further include a vertical axis 812, which can define a height (or thickness) of the body 801. As illustrated, the vertical axis 812 can extend along the side surface 804 between the first and second major surfaces 802 and 803 in a direction generally perpendicular to the plane defined by the axes 810 and 811 on the first major surface. For thin-shaped bodies, such as the CHAP illustrated in FIG. 8A, the length can be equal to or greater than the width and the length can be greater than the height. It will be appreciated that reference herein to length, width, and height of the abrasive particles may be referenced to average values taken from a suitable sampling size of abrasive particles of a batch of abrasive particles.

Unlike the shaped abrasive particles of FIGS. 5A, 5B, and 7, the CHAP of FIG. 8A does not have a readily identifiable two-dimensional shape based on the perimeter of the first or second major surfaces 802 and 803. Such abrasive particles may be formed in a variety of ways, including but not limited to, fracturing of a thin layer of material to form abrasive particles having a controlled height but with irregularly formed, planar, major surfaces. For such particles, the longitudinal axis is defined as the longest dimension on the major surface that extends through a midpoint on the surface. To the extent that the major surface has undulations, the longitudinal axis can be determined using a top-down, two-dimensional image that ignores the undulations. Moreover, as noted above in FIG. 5B, a closest-fit circle may be used to identify the midpoint of the major surface and identification of the longitudinal and lateral axes.

FIG. 8B includes an illustration of a non-shaped particle, which may be an elongated, non-shaped abrasive particle or a secondary particle, such as a diluent grain, a filler, an agglomerate, or the like. Shaped abrasive particles may be formed through particular processes, including molding, printing, casting, extrusion, and the like. Shaped abrasive particles can be formed such that each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a relatively high shape fidelity and consistency in the arrangement of the surfaces and edges relative to each other. Moreover, constant height abrasive particles (CHAPs) can also be formed through particular processes that facilitate the formation of thin-shaped bodies that can have irregular two-dimensional shapes when viewing the major surface top-down. CHAPs can have less shape fidelity than shaped abrasive particles but can have substantially planar and parallel major surfaces separated by a side surface.

By contrast, non-shaped particles can be formed through different processes and have different shape attributes compared to shaped abrasive particles and CHAPs. For example, non-shaped particles are typically formed by a comminution process wherein a mass of material is formed and then crushed and sieved to obtain abrasive particles of a certain size. However, a non-shaped particle will have a generally random arrangement of surfaces and edges, and generally will lack any recognizable two-dimensional or three-dimensional shape in the arrangement of the surfaces and edges. Moreover, non-shaped particles do not necessarily have a consistent shape with respect to each other, and therefore have a significantly lower shape fidelity compared to shaped abrasive particles or CHAPs. The non-shaped particles generally are defined by a random arrangement of surfaces and edges for each particle and with respect to other non-shaped particles.

FIG. 8B includes a perspective view illustration of a non-shaped particle. The non-shaped particle 850 can have a body 851 including a generally random arrangement of edges 855 extending along the exterior surface of the body 851. The body can further include a longitudinal axis 852 defining the longest dimension of the particle. The longitudinal axis 852 defines the longest dimension of the body as viewed in two-dimensions. Thus, unlike shaped abrasive particles and CHAPs, where the longitudinal axis is measured on the major surface, the longitudinal axis of a non-shaped particle is defined by the points on the body furthest from each other as the particle is viewed in two-dimensions using an image or vantage that provides a view of the particle's longest dimension. That is, an elongated particle, but non-shaped particles, such as illustrated in FIG. 8B, should be viewed in a perspective that makes the longest dimension apparent to properly evaluate the longitudinal axis. The body 851 can further include a lateral axis 853 extending perpendicular to the longitudinal axis 852 and defining a width of the particle. The lateral axis 853 can extend perpendicular to the longitudinal axis 852 through the midpoint 856 of the longitudinal axis in the same plane used to identify the longitudinal axis 852. The abrasive particle may have a height (or thickness) as defined by the vertical axis 854. The vertical axis 854 can extend through the midpoint 856 but in a direction perpendicular to the plane used to define the longitudinal axis 852 and lateral axis 853. To evaluate the height, one may have to change the perspective of view of the abrasive particle to look at the particle from a different vantage than is used to evaluate the length and width.

In an embodiment, the plurality of abrasive particles 102 and 103 of the coated abrasive article can include shaped abrasive particles. In an embodiment, the shaped abrasive particles can be 3-PT star-shaped abrasive particles. The abrasive particles can have a length (l), a width (w), and a thickness (t), wherein the width≥thickness and the length≥thickness. The particles can have a primary aspect ratio based on the length:width of the body. The particles can have a secondary aspect ratio based on the length:thickness of the body. The particles can also have a tertiary aspect ratio, based on the width:thickness of the body. The particles 102 and 103 can be an elongated abrasive particle, having a primary aspect ratio greater than 1.1:1.

In an embodiment, the plurality of shaped abrasive particles can include a plurality of shaped abrasive particles having a 3-PT star two-dimensional shape as viewed in a plane of a length and width of the body. The body can include at least 3 exterior corners and at least 4 side surface sections, or at least 5 side surface sections or at least 6 side surface sections. In an embodiment, the plurality of shaped abrasive particles can include a body having at least 3 exterior corners, where the sum of the angles of the exterior corners is less than 180 degrees. In an embodiment, the plurality of shaped abrasive particles can include a body having at least 3 exterior corners, where each of the exterior corners defines an angle less than 60 degrees, or less than 59 degrees, or less than 58 degrees, or less than 57 degrees, or less than 56 degrees, or less than 55 degrees. In an embodiment, the plurality of shaped abrasive particles can include comprises a body having at least 3 exterior corners and at least 3 interior corners, where each of the interior corners have an interior corner angle value greater than any of the exterior corner values of any of the at least 3 exterior corners.

Exterior corners can be identified using the “rubber band test.” If a rubber band were to be stretched around the body of the abrasive particle, the corners that contact the rubber band and cause deflection of the rubber band would be exterior corners.

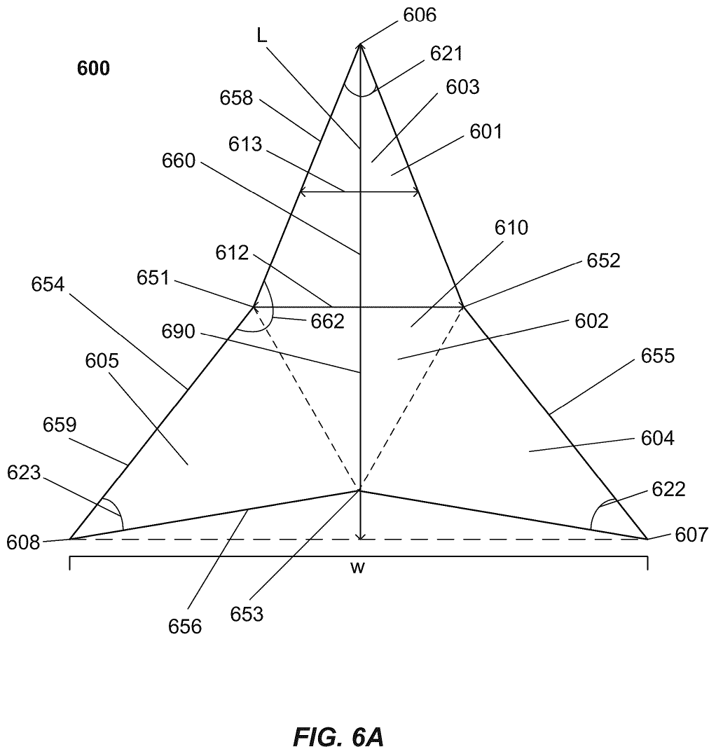

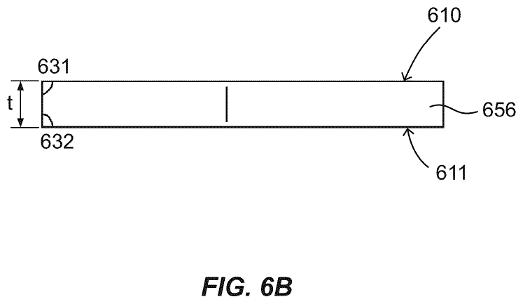

FIG. 6A includes a top view image of a 3-PT star-shaped abrasive particle according to a particular embodiment. As illustrated, the shaped abrasive particle 600 can define a star-shaped body, as viewed in two dimensions. In particular, the shaped abrasive particle 600 can include a body 601 having a central portion 602 and a first arm 603, a second arm 604, and a third arm 605 extending from the central portion 602. The body 601 can have a length (l) measured as the longest dimension along a side of the particle and a width (w), measured as the longest dimension of the particle between a midpoint 653 of a side through the midpoint 690 of the body 601 to a first tip 606 of the first arm 603. The width can extend in a direction perpendicular to the dimension of the length. The body 601 can have a thickness (t), extending in a direction perpendicular to the upper surface or first major surface 610 of the body 601 defining the third side surface 656 between the upper surface or first major surface 610 and the base surface 611 as illustrated in FIG. 6B, which is a side view illustration of the image of the particle of FIG. 6A.

The shaped abrasive particle 600 can have a body 601 in the form of a 3-PT star defined by the first arm 603, second arm 604, and the third arm 605 extending from the central portion 602. According to one particular embodiment, at least one of the arms, including, for example, the first arm 603, can have a midpoint width 613 that is less than a central portion width 612. The central portion 602 can be defined as a region between the midpoints 651, 652, and 653 of the first side surface 654, second side surface 655, and third side surface 656, respectively. The central portion width 612 of the first arm 603 can be the width of the dimension between the midpoints 651 and 652. The midpoint width 613 can be the width of the line at a midpoint between the line of the central portion width 612 and the tip 606 of the first arm 603 along a first axis 660. In certain instances, the midpoint width 613 can be not greater than about 90% of the central portion width 612, such as not greater than about 80%, not greater than about 70%, not greater than about 5%, or even not greater than about 60%. Still, the midpoint width 613 can be at least about 10%, such as at least about 20%, at least about 30%, or even at least about 40% of the central portion width 612. It will be appreciated that the midpoint width 613 can have a width relative to the central portion width 612 within a range between any of the above minimum and maximum percentages.

Moreover, the body 601 can have at least one arm, such as the first arm 603, having a tip width at the tip 606 of the first arm 603 that is less than a midpoint width 613. In such instances wherein the tip 606 is sharply formed, the tip width may be considered 0. In instances wherein the tip 606 has a radius of curvature, the tip width may be considered the diameter of the circle defined by the radius of curvature. According to one embodiment, the tip width 614 can be not greater than about 90% of the midpoint width 613, such as not greater than about 80%, not greater than about 70%, not greater than about 60%, not greater than about 50%, not greater than about 40%, not greater than about 30%, not greater than about 20%, or even not greater than about 10%. Still, in certain non-limiting embodiments, the tip width 614 can be at least about 1%, such as at least about 2%, at least about 3%, at least about 5%, or even at least about 10% of the midpoint width 613. It will be appreciated that the tip width 614 can have a width relative to the midpoint width 613 within a range between any of the above minimum and maximum percentages.

As further illustrated, the body 601 can have a first arm 603 including a first tip 606 defining a first tip angle 621 between the first side surface 654 and the second side surface 655. According to an embodiment, the first tip angle can be less than about 60 degrees, such as not greater than about 55 degrees, not greater than about 50 degrees, not greater than about 45 degrees, or even not greater than about 40 degrees. Still, the first tip angle can be at least about 5 degrees, such as at least about 8 degrees, at least about 10 degrees, at least about 15 degrees, at least about 20 degrees, at least about 25 degrees, or even at least about 30 degrees. The first tip angle can be within a range between any of the minimum and maximum values noted above.

The body 601 can include a second arm 604 having a second tip 607 defining a second tip angle 622 between the second side surface 655 and third side surface 656. The second tip angle can be substantially the same as the first tip angle, such as within 5% of the angle numerical value. Alternatively, the second tip angle can be substantially different relative to the first tip angle.

The body 601 can include a third arm 605 having a third tip 608 defining a third tip angle 623 between the first side surface 654 and third side surface 656. The third tip angle can be substantially the same as the first tip angle or second tip angle, such as within 5% of the angle numerical value. Alternatively, the third tip angle can be substantially different relative to the first tip angle or the second tip angle.

The body 601 can have a total angle, which is a sum of the value of the first tip angle, second tip angle, and third tip angle which can be less than about 180 degrees. In other embodiments, the total angle can be not greater than about 175 degrees, such as not greater than about 170 degrees, not greater than about 15 degrees, not greater than about 150 degrees, such as not greater than about 140 degrees, not greater than about 130 degrees, not greater than about 125 degrees, or even not greater than about 120 degrees. Still, in one non-limiting embodiment, the body 601 can have a total angle of at least about 60 degrees, such as at least about 70 degrees, at least about 80 degrees, at least about 90 degrees, such as at least about 95 degrees, at least about 100 degrees, or even at least about 105 degrees. It will be appreciated that the total sum angle can be within a range between any of the minimum and maximum values noted above.

As noted herein, the body 601 can have a first side surface 654 extending between the first arm 606 and the third arm 608. In certain instances, the first side surface 654 can have an arcuate contour.

Referring again to FIG. 6A, the body 601 can have a first side surface 654 having a first side section 658 and a second side section 659. The first side section 658 can extend between the first tip 606 and the midpoint 651 and the second side section 659 can extend between the third tip 608 and the midpoint 651. The first side section 658 and second side section 659 can define an interior angle 662 that can be obtuse. For example, the interior angle 662 can be greater than about 90 degrees, such as greater than about 95 degrees, greater than about 100 degrees, greater than about 110 degrees, or even greater than about 120 degrees. Still, in one non-limiting embodiment, the interior angle 662 can be not greater than about 320 degrees, such as not greater than about 300 degrees, or even not greater than about 270 degrees. It will be appreciated that the interior angle can be within a range between any of the minimum and maximum values noted above.

The first side section 658 can extend for a significant portion of the length of the first side surface 654. For example, the first side section 658 can extend for at least about 20%, such as at least about 25%, at least about 30%, at least about 35%, or even at least about 40% of a total length of the first side surface 654. Still, in one non-limiting embodiment, the first side section 658 can have a length (ls1) between the midpoint 651 and the first tip 606 of not greater than about 80%, such as not greater than about 75%, not greater than about 70%, or even not greater than about 5% of the total length of the side surface 654. It will be appreciated that the length of the first side section 658 can be within a range between any of the minimum and maximum percentages noted above.

The second side section 659 can extend for a significant portion of the length of the first side surface 654. For example, the second side section 659 can extend for at least about 20%, such as at least about 25%, at least about 30%, at least about 35%, or even at least about 40% of a total length of the first side surface 654. Still, in one non-limiting embodiment, the second side section 659 can have a length (ls2) between the midpoint 651 and the third tip 608 of not greater than about 80%, such as not greater than about 75%, not greater than about 70%, or even not greater than about 5% of the total length of the side surface 654 as a straight line between the first tip 606 and the third tip 608. It will be appreciated that the length of the second side section 659 can be within a range between any of the minimum and maximum percentages noted above.

The body 601 can include a first average side surface angle 631 between the side surfaces 654, 655, and 656 and the upper surface or first major surface 610. The body can also include a second side surface angle 632 between the side surfaces 654, 655, and 656 and the second major surface or base surface 612.

In an embodiment, the abrasive particles may include a particular first side surface angle that may facilitate improved performance and/or manufacturing of the abrasive particles. In an embodiment, the first side surface angle can be within a range of at least 70 degrees and not greater than 94 degrees, or within a range of at least 80 degrees and not greater than 93 degrees, or within a range of at least 83 degrees and not greater than 92 degrees, or within a range of at least 85 degrees and not greater than 91 degrees.

In an embodiment, the abrasive particles may include a particular second side surface angle that may facilitate improved performance and/or manufacturing of the abrasive particles. In an embodiment, the second side surface angle can be within a range of at least 70 degrees and not greater than 94 degrees, or within a range of at least 80 degrees and not greater than 93 degrees, or within a range of at least 83 degrees and not greater than 92 degrees, or within a range of at least 85 degrees and not greater than 91 degrees.

While the foregoing body 601 of the 3-PT star has been shown to have an upper surface 610 having a two-dimensional shape, as viewed in the plane of the length and width of the body, that is substantially the same as the two-dimensional shape of the base surface or second major surface 611 of the body 601, other shapes are contemplated. For example, in one embodiment, the cross-sectional shape of the body at the base surface can define a base surface shape from the group consisting of a 3-PT star, a 4-PT star, a cross-shape, a polygon, ellipsoids, numerals, Greek alphabet characters, Latin alphabet characters, Russian alphabet characters, complex shapes having a combination of polygonal shapes, and a combination thereof. Moreover, the cross-sectional shape of the body at the upper surface can define an upper surface shape, which can be different than the base surface shape and selected from the group of a 3-PT star, a 4-PT star, a cross-shape, a polygon, ellipsoids, numerals, Greek alphabet characters, Latin alphabet characters, Russian alphabet characters, complex shapes having a combination of polygonal shapes, and a combination thereof.

In particular instances, the upper surface shape can have an arcuate form of the base surface shape. For example, the upper surface shape can define an arcuate 3-PT two-dimensional shape, wherein the arcuate 3-PT two-dimensional shape defines arms having rounded ends. In particular, the arms as defined at the base surface can have a smaller radius of curvature at the tip as compared to the radius of curvature of the corresponding tip at the upper surface.

As described in other embodiments herein, it will be appreciated that at least one of the arms of the body 601 may be formed to have a twist, such that the arm twists around a central axis. For example, the first arm 603 may twist around the axis 660. Moreover, the body 601 can be formed such that at least one arm extends in an arcuate path from the central region.

In an embodiment, the plurality of shaped abrasive particles may define a first group of abrasive particles. In an embodiment, the first group of abrasive particles may include at least two different types of shaped abrasive particles, wherein the two different types of shaped abrasive particles are different from each other based on at least one characteristic selected from the group of particle size, two-dimensional shape, three-dimensional shape, composition, hardness, toughness, friability, density, grain size, agglomeration state, lateral position, longitudinal position, rotational orientation, or any combination thereof.

In an embodiment, the abrasive article may include a second group of abrasive particles different than the first group of abrasive particles. The second group of abrasive particles can be different from the first group of abrasive particles based on at least one characteristic selected from the group of particle size, two-dimensional shape, three-dimensional shape, composition, hardness, toughness, friability, density, grain size, agglomeration state, lateral position, longitudinal position, rotational orientation, or any combination thereof. In a further embodiment, the second group of abrasive particles comprises diluent abrasive particles. In another embodiment, the second group of particles can include randomly shaped or non-shaped abrasive particles.

Shaped abrasive particles may be formed through particular processes, including molding, printing, casting, extrusion, and the like. Shaped abrasive particles can be formed such that each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a relatively high shape fidelity and consistency in the arrangement of the surfaces and edges relative to each other. By contrast, non-shaped particles can be formed through different processes and have different shape attributes compared to shaped abrasive particles/For example, non-shaped particles are typically formed by a comminution process wherein a mass of material is formed and then crushed and sieved to obtain abrasive particles of a certain size. However, a non-shaped particle will have a generally random arrangement of surfaces and edges, and generally will lack any recognizable two-dimensional or three-dimensional shape in the arrangement of the surfaces and edges. Moreover, non-shaped particles do not necessarily have a consistent shape with respect to each other, and therefore have a significantly lower shape fidelity compared to shaped abrasive particles. The non-shaped particles generally are defined by a random arrangement of surfaces and edges for each particle and with respect to other non-shaped particles.

In an embodiment, the abrasive article can include a certain percentage of cracked abrasive particles that may facilitate improved performance or manufacturing of the abrasive article. As defined herein, cracks in the plurality of shaped abrasive particles include cracks visible with a magnification such that the width of the particle is equal to 50% to 95% of the field of view. In an embodiment, the abrasive article can include a plurality of shaped abrasive particles having at least 3 interior corners where not greater than 50% of the total number of shaped abrasive particles have a crack at an interior corner on the first major surface or not greater than 45%, or not greater than 40%, or not greater than 35%, or not greater than 30%, or not greater than 25%, or not greater than 20%, or not greater than 18%, or not greater than 16%, or not greater than 14%, or not greater than 12%, or not greater than 10%, or not greater than 9%, or not greater than 8%, or not greater than 7%, or not greater than 6%, or not greater than 5%, or not greater than 4%, or not greater than 3%, or not greater than 2%, or not greater than 1%. In an embodiment, the abrasive article can include a plurality of shaped abrasive particles having at least 3 interior corners where not greater than 50% of the total number of shaped abrasive particles have a crack at an interior corner on the first major surface or not greater than 45%, or not greater than 40%, or not greater than 35%, or not greater than 30%, or not greater than 25%, or not greater than 20%, or not greater than 18%, or not greater than 16%, or not greater than 14%, or not greater than 12%, or not greater than 10%, or not greater than 9%, or not greater than 8%, or not greater than 7%, or not greater than 6%, or not greater than 5%, or not greater than 4%, or not greater than 3%, or not greater than 2%, or not greater than 1%. In an embodiment, the abrasive article can include a plurality of shaped abrasive particles having a body having at least 3 interior corners, and wherein at least 0.01% of the total number of shaped abrasive particles have a crack at an interior corner on the first major surface or at least 0.5%, or at least 1%, or at least 2%, or at least 3%, or at least 4%, or at least 5%, or at least 8%, or at least 10%. In an embodiment, the abrasive article can include a plurality of shaped abrasive particles having a body having at least 3 interior corners, and wherein at least 0.01% of the total number of shaped abrasive particles have a crack at an interior corner on the second major surface or at least 0.5%, or at least 1%, or at least 2%, or at least 3%, or at least 4%, or at least 5%, or at least 8%, or at least 10%. It will be appreciated that the percentage of the plurality of shaped abrasive particles having a crack at an interior corner may be between any of the minimum and maximum values noted above, including, for example, but not limited to at least 0.5% and not greater than 50%, or at least 5% and not greater than 30%.

In an embodiment, the abrasive article may include a plurality of shaped abrasive particles of a particular material that may facilitate improved manufacturing or performance of the abrasive article. In an embodiment, the abrasive article may include a plurality of shaped abrasive particles including a ceramic material. In an embodiment, the abrasive article may include a plurality of shaped abrasive particles including at least one of a nitride, oxide, carbide, boride, oxynitride, oxyboride, diamond, carbon-containing material, or any combination thereof. In an embodiment, the abrasive article may include a plurality of shaped abrasive particles including an oxide compound or complex, such as aluminum oxide, zirconium oxide, titanium oxide, yttrium oxide, chromium oxide, strontium oxide, silicon oxide, magnesium oxide, rare-earth oxides, or any combination thereof.

In an embodiment, the abrasive article can include abrasive particles having at least one fracture feature. The fracture feature may encourage fracturing when the abrasive particle is in a front facing orientation relative to the grinding direction without encouraging fracturing when the abrasive particle is in a side facing orientation relative to the grinding direction. In an embodiment, the fracture feature can be located on a first major surface of the abrasive particle. In a more particular embodiment, the abrasive particles may include a fracture feature on at least a first major surface and a fracture feature on at least a second major surface. In an alternative embodiment, the fracture feature can be on a side surface. In another embodiment, at least 2 side surfaces of an abrasive particle can include fracture features. In an embodiment, the fracture feature can be continuous. In an alternative embodiment, the fracture feature can be discontinuous. In an embodiment, the fracture feature can be a semicircular indentation in a surface of the abrasive particle.

The abrasive particles may have a fracture feature with a particular depth that may facilitate improved performance and/or manufacturing of the abrasive article. In an embodiment the abrasive particles can include a fracture feature with a depth of at least 5 microns, or at least 6 microns, or at least 7 microns, or at least 8 microns, or at least 9 microns, or at least 10 microns, or at least 11 microns, or at least 12 microns, or at least 13 microns, or at least 14 microns, or at least 15 microns. In an embodiment, the abrasive particles can include a fracture feature with a depth of no greater than 80 microns, or no greater than 75 microns, or no greater than 70 microns, or no greater than 65 microns, or no greater than 60 microns, or no greater than 55 microns, or no greater than 50 microns, or no greater than 45 microns, or no greater than 40 microns, or no greater than 35 microns, or no greater than 30 microns, or no greater than 25 microns, or no greater than 20 microns, or no greater than 15 microns. It will be appreciated that the depth of the fracture feature may be between any of the minimum and maximum values noted above including, for example, but not limited to, at least 6 microns and less than 75 microns, or at least 10 microns and less than 20 microns.

The abrasive particles may have a fracture feature at a certain height relative to the total height, H, of the abrasive particle that may facilitate improved performance and/or manufacturing of the abrasive article. In an embodiment, the abrasive particles can include a fracture feature at a height of at least 55% H or at least 56% H or at least 57% H or at least 58% H or at least 59% H or at least 60% H or at least 61% H or at least 62% H or at least 63% H or at least 64% H or at least 65% H or at least 66% H or at least 67% H or at least 68% H or at least 69% H or at least 70% H or at least 71% H or at least 72% H or at least 73% H or at least 74% H or at least 75% H. In an embodiment, the abrasive particles can include a fracture feature at a height of less than 90% H or less than 89% H or less than 88% H or less than 87% H or less than 86% H or less than 85% H or less than 84% H or less than 83% H or less than 82% H or less than 81% H or less than 80% H or less than 79% H or less than 78% H or less than 77% H or less than 76%. It will be appreciated that the height of the fracture feature may be between any of the minimum and maximum values noted above including, for example, but not limited to, at least 55% H and not greater than 90% H or at least 62% H and not greater than 87% H.

In an embodiment, the abrasive particles may have a fracture feature having a particular radius of curvature that may facilitate improved performance and/or manufacturing of the abrasive article. The radius of curvature may be determined by superimposing a best fit circle to the curvature of the fracture feature and determining the radius of the best fit circle. Any suitable computer program, such as ImageJ may be used in conjunction with an image (e.g., SEM image or light microscope image) of suitable magnification of the abrasive particle to accurately measure the best fit circle. In an embodiment, the abrasive particles may have a fracture feature having a radius of curvature of at least 100 microns or at least 110 microns or at least 120 microns or at least 130 microns or at least 140 microns or at least 150 microns or at least 160 microns or at least 170 microns or at least 180 microns or at least 190 microns or at least 200 microns or at least 210 microns or at least 220 microns or at least 230 microns or at least 240 microns or at least 250 microns or at least 260 microns or at least 270 microns or at least 280 microns or at least 290 microns or at least 300 microns or at least 310 microns or at least 320 microns or at least 330 microns or at least 340 microns or at least 350 microns or at least 360 microns or at least 370 microns or at least 380 microns or at least 390 microns or at least 400 microns or at least 410 microns or at least 420 microns or at least 430 microns or at least 440 microns or at least 450 microns or at least 460 microns or at least 470 microns or at least 480 microns. In still other embodiments, the abrasive particles may have a fracture feature having a radius of curvature of not greater than 3000 microns or not greater than 2500 microns or not greater than 2000 microns or not greater than 1900 microns or not greater than 1800 microns or not greater than 1700 microns or not greater than 1600 microns or not greater than 1500 microns or not greater than 1400 microns or not greater than 1300 microns or not greater than 1200 microns or not greater than 1100 microns or not greater than 1000 microns or not greater than 900 microns or not greater than 800 microns or not greater than 700 microns or not greater than 600 microns or not greater than 500 microns. It will be appreciated that the radius of curvature of the fracture feature may be between any of the minimum and maximum values noted above including, for example, but not limited to, at least 100 microns and not greater than 3000 microns, or at least 400 microns and not greater than 500 microns. In still other embodiments, it will be appreciated that the fracture feature of the abrasive particle may be a straight line having no radius of curvature.

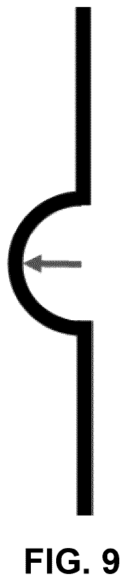

In an embodiment, the abrasive particles may have a fracture feature defined by a semicircular indentation having a particular indentation radius of curvature that may facilitate improved performance and/or manufacturing of the abrasive article. The indentation radius of curvature may be determined by superimposing a best fit circle to the curvature of the fracture feature indentation and determining the radius of the best fit circle. Any suitable computer program, such as ImageJ may be used in conjunction with an image (e.g., SEM image or light microscope image) of suitable magnification of the abrasive particle to accurately measure the best fit circle. For example, FIG. 9 includes a side view of a fracture feature having a particular indentation radius of curvature. In an embodiment, the abrasive particles may have a fracture feature having an indentation radius of curvature of at least 5 microns at least 10 microns at least 15 microns or at least 20 microns or at least 25 microns or at least 30 microns or at least 35 microns or at least 40 microns or at least 45 microns or at least 50 microns. In still other embodiments, the abrasive particles may have a fracture feature having an indentation radius of curvature of not greater than 100 microns or not greater than 90 microns or not greater than 80 microns or not greater than 70 microns or not greater than 60 microns or not greater than 50 microns or not greater than 40 microns or not greater than 30 microns or not greater than 20 microns. It will be appreciated that the indentation radius of curvature of the fracture feature may be between any of the minimum and maximum values noted above including, for example, but not limited to, at least 5 microns and not greater than 100 microns, or at least 10 microns and not greater than 20 microns.

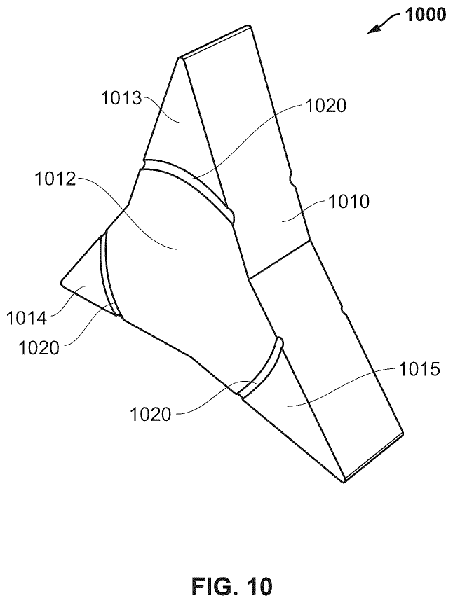

In a particular embodiment, the abrasive particles may comprise a 3-PT star two-dimensional shape as viewed in a plane of a length and width of the body. For example, FIG. 10 includes a perspective view of a 3-PT star shaped abrasive particle 1000 having fracture features as described herein. The shaped abrasive particle 1000 may include a body 1010 having a central portion 1012 and a first arm 1013, a second arm 1014, and a third arm 1015 extending from the central portion 1012. In an embodiment, each of the arms 1013, 1014, 1015 may include a fracture feature 1020 having a semicircular indentation. In an embodiment, the fracture feature 1020 of each of the arms 1013, 1014, 1015 may have the same radius of curvature. In still another embodiment, the fracture feature 1020 of each of the arms 1013, 1014, 1015 may have a different radius of curvature.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. An abrasive particle comprising:
a first major surface,
a second major surface,
a side surface between the first major surface and the second major surface,
a total height, H,
and at least one fracture feature located at a height of 55%-90% H.

Embodiment 2. The abrasive particle of embodiment 1, wherein the at least one fracture feature is located on the first major surface.

Embodiment 3. The abrasive particle of embodiment 1, wherein the abrasive particle comprises at least one fracture feature on the first major surface and at least 1 fracture feature on the second major surface.

Embodiment 4. The abrasive particle of embodiment 1, wherein the at least one fracture feature is on a side surface.

Embodiment 5. The abrasive particle of embodiment 1, wherein at least two fracture features are located on different side surfaces.

Embodiment 6. The abrasive particle of embodiment 1, wherein the fracture feature is at a height of at least 56% H or at least 57% H or at least 58% H or at least 59% H or at least 60% H or at least 61% H or at least 62% H or at least 63% H or at least 64% H or at least 65% H or at least 66% H or at least 67% H or at least 68% H or at least 69% H or at least 70% H or at least 71% H or at least 72% H or at least 73% H or at least 74% H or at least 75% H.

Embodiment 7. The abrasive particle of embodiment 1, wherein the fracture feature is at a height of less than 89% H or less than 88% H or less than 87% H or less than 86% H or less than 85% H or less than 84% H or less than 83% H or less than 82% H or less than 81% H or less than 80% H or less than 79% H or less than 78% H or less than 77% H or less than 76% H.

Embodiment 8. The abrasive particle of embodiment 1, wherein the fracture feature is a semicircular indentation in a surface of the abrasive particle.

Embodiment 9. The abrasive particle of embodiment 8, wherein the fracture feature is discontinuous.

Embodiment 10. The abrasive particle of embodiment 8, wherein the fracture feature is continuous.

Embodiment 11. The abrasive particle of embodiment 1, wherein the fracture feature has a depth of at least 5 microns, or at least 6 microns, or at least 7 microns, or at least 8 microns, or at least 9 microns, or at least 10 microns, or at least 11 microns, or at least 12 microns, or at least 13 microns, or at least 14 microns, or at least 15 microns.

Embodiment 12. The abrasive particle of embodiment 1, wherein the fracture feature has a depth of no greater than 80 microns, or no greater than 75 microns, or no greater than 70 microns, or no greater than 65 microns, or no greater than 60 microns, or no greater than 55 microns, or no greater than 50 microns, or no greater than 45 microns, or no greater than 40 microns, or no greater than 35 microns, or no greater than 30 microns, or no greater than 25 microns, or no greater than 20 microns, or no greater than 15 microns.

Embodiment 13. The abrasive particle of embodiment 1, wherein the abrasive is a shaped or elongated particle having a length (l), a width (w) and a thickness (t), wherein the width>thickness and the length>thickness.

Embodiment 14. The abrasive particle of embodiment 1, wherein the abrasive particle comprises a 3-PT star two-dimensional shape as viewed in a plane of a length and width of the body.

Embodiment 15. The abrasive particle of embodiment 1, further comprising at least 3 exterior corners and wherein the side surface comprises at least 4 side surface sections, or at least 5 side surface sections or at least 6 side surface sections.

Embodiment 16. The abrasive particle of embodiment 1, further comprising an average side surface angle between the side surface and the first major surface of at least 70 degrees and not greater than 94 degrees, or within a range of at least 80 degrees and not greater than 93 degrees, or within a range of at least 83 degrees and not greater than 92 degrees, or within a range of at least 85 degrees and not greater than 91 degrees.

Embodiment 17. The abrasive particle of embodiment 1, further comprising an average side surface angle between the side surface and the second major surface of at least 70 degrees and not greater than 94 degrees, or within a range of at least 80 degrees and not greater than 93 degrees, or within a range of at least 83 degrees and not greater than 92 degrees, or within a range of at least 85 degrees and not greater than 91 degrees.

Embodiment 18. The abrasive particle of embodiment 1, further comprising a body having at least 3 exterior corners, wherein the sum of the angles of the exterior corners is less than 180 degrees.

Embodiment 19. The abrasive particle of embodiment 1, further comprising at least 3 exterior corners, wherein each of the exterior corners defines an angle less than 60 degrees, or less than 59 degrees, or less than 58 degrees, or less than 57 degrees, or less than 56 degrees, or less than 55 degrees.

Embodiment 20. The abrasive particle of embodiment 1, further comprising at least 3 exterior corners and at least 3 interior corners, wherein each of the interior corners have an interior corner angle value greater than any of the exterior corner values of any of the at least 3 exterior corners.

Embodiment 21. The abrasive particle of embodiment 1, further comprising at least 3 interior corners, and wherein not greater than 50% of the total number of a plurality of shaped abrasive particles or elongated abrasive particles have a crack at an interior corner or not greater than 45%, or not greater than 40%, or not greater than 35%, or not greater than 30%, or not greater than 25%, or not greater than 20%, or not greater than 18%, or not greater than 16%, or not greater than 14%, or not greater than 12%, or not greater than 10%, or not greater than 9%, or not greater than 8%, or not greater than 7%, or not greater than 6%, or not greater than 5%, or not greater than 4%, or not greater than 3%, or not greater than 2%, or not greater than 1%.

Embodiment 22. The abrasive particle of embodiment 1, further comprising at least 3 interior corners, and wherein at least 0.01% of the total number of a plurality of shaped abrasive particles or elongated abrasive particles have a crack at an interior corner or at least 0.5%, or at least 1%, or at least 2%, or at least 3%, or at least 4%, or at least 5%, or at least 8%, or at least 10%.

Embodiment 23. The abrasive particle of embodiment 1, further comprising a ceramic material.

Embodiment 24. The abrasive particle of embodiment 1, further comprising at least one of a nitride, oxide, carbide, boride, oxynitride, oxyboride, diamond, carbon-containing material, or any combination thereof.

Embodiment 25. The abrasive particle of embodiment 1, further comprising an oxide compound or complex, such as aluminum oxide, zirconium oxide, titanium oxide, yttrium oxide, chromium oxide, strontium oxide, silicon oxide, magnesium oxide, rare-earth oxides, or any combination thereof.

Embodiment 26. The abrasive particle of embodiment 1, further comprising alumina.

Embodiment 27. An abrasive article comprising:
a backing:
an abrasive layer comprising abrasive particles and a binder;
wherein the abrasive particles comprise a random rotational orientation;
wherein the abrasive particles comprise a total height, H, and a fracture feature located at a height of 55%-90% H.

Embodiment 28. The abrasive article of embodiment 27, wherein the abrasive particles comprise the abrasive particles of any one of embodiments 1-26.

Embodiment 29. The abrasive article of embodiment 27, wherein the abrasive particles consist of the abrasive particles of any one of embodiments 1-26.

Embodiment 30. The abrasive article of embodiment 27, further comprising a standing portion of abrasive particles have a standing orientation, wherein the standing portion includes at least 10% of the total number of the abrasive particles or at least 20%, or at least 30%, or at least 40%, or at least 50%, or at least 55%, or at least 57%, or at least 60%, or at least 62%, or at least 65%, or at least 67%, or at least 70%, or at least 72%, or at least 75%, or at least 77%, or at least 80%, or at least 82%, or at least 85%, or at least 87%, or at least 90% of the total number of the abrasive particles.

Embodiment 31. The abrasive article of embodiment 30, wherein the standing portion is not greater than 99.9% of the total number of the abrasive particles or not greater than 99%, or not greater than 98%, or not greater than 97%, or not greater than 96%, or not greater than 95% of the total number of the abrasive particles.

Embodiment 32. The abrasive article of embodiment 27, further comprising a slanted portion of abrasive particles have a slanted orientation, wherein the slanted portion includes at least 1% of the total number of the abrasive particles or at least 2%, or at least 3%, or at least 4%, or at least 5%, or at least 6%, or at least 7%, or at least 8%, or at least 9%, or at least 10%, or at least 11%, or at least 12%, or at least 13%, or at least 14%, or at least 15%, or at least 16%, or at least 17%, or at least 18%, or at least 20%, or at least 25% of the total number of the abrasive particles.

Embodiment 33. The abrasive article of embodiment 32, wherein the slanted portion is not greater than 90% of the total number of the abrasive particles or not greater than 85%, or not greater than 80%, or not greater than 75%, or not greater than 70%, or not greater than 65%, or not greater than 60%, or not greater than 55%, or not greater than 50%, or not greater than 45%, or not greater than 40%, or not greater than 35%, or not greater than 30%, or not greater than 25%, or not greater than 20%, or not greater than 18%, or not greater than 15%, or not greater than 12%, or not greater than 10% of the total number of the abrasive particles.

Embodiment 34. The abrasive article of embodiment 27, further comprising a standing portion of abrasive particles (Pst) having a standing orientation and a slanted portion (Psl) of abrasive particles having a slanted orientation, and further comprising a ratio of the standing portion relative to the slanted portion (Pst/Psl) of at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6.

Embodiment 35. The abrasive article of embodiment 34, wherein the ratio of the standing portion relative to the slanted portion (Pst/Psl) is not greater than 100, or not greater than 95, or not greater than 90, or not greater than 80, or not greater than 70, or not greater than 60, or not greater than 50, or not greater than 40, or not greater than 30, or not greater than 20, or not greater than 10.

Embodiment 36. The abrasive article of embodiment 27, further comprising a fallen portion of abrasive particles have a fallen orientation, wherein the fallen portion includes at least 0.1% of the total number of the abrasive particles or at least 0.2%, or at least 0.4%, or at least 0.6%, or at least 0.8%, or at least 1%, or at least 1.5%, or at least 2%, or at least 2.5%, or at least 3%, or at least 3.5%, or at least 4%, or at least 4.5%, or at least 5% of the total number of the abrasive particles.

Embodiment 37. The abrasive article of embodiment 36, wherein the fallen portion is not greater than 20% of the total number of the abrasive particles or not greater than 18%, or not greater than 15%, or not greater than 12%, or not greater than 10%, or not greater than 9%, or not greater than 8%, or not greater than 7%, or not greater than 6%, or not greater than 5% of the total number of the abrasive particles.

Embodiment 38. The abrasive article of embodiment 27, further comprising a standing portion of abrasive particles (Pst) having a standing orientation and a fallen portion (Pf) of abrasive particles having a fallen orientation, and further comprising a ratio of the standing portion relative to the fallen portion (Pst/Pf) of at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6, or at least 5.8, or at least 6.0, or at least 6.2, or at least 6.4, or at least 6.6, or at least 6.8, or at least 7.0, or at least 7.2, or at least 7.4, or at least 7.6, or at least 7.8, or at least 8.0.

Embodiment 39. The abrasive article of embodiment 38, wherein the ratio of the standing portion relative to the fallen portion (Pst/Pf) is not greater than 1000, or not greater than 800, or not greater than 500, or not greater than 200, or not greater than 100, or not greater than 95.

Embodiment 40. The abrasive article of embodiment 27, further comprising a slanted portion of abrasive particles (Psl) having a slanted orientation and a fallen portion (Pf) of abrasive particles having a fallen orientation, and further comprising a ratio of the slanted portion relative to the fallen portion (Psl/Pf) of at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6.

Embodiment 41. The abrasive article of embodiment 40, wherein the ratio of the slanted portion relative to the fallen portion (Psl/Pf) is not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6.

Embodiment 42. The abrasive article of embodiment 27, further comprising an inverted portion of abrasive particles have an inverted orientation, wherein the inverted portion includes at least 0.1% of the total number of the abrasive particles or at least 0.2%, or at least 0.4%, or at least 0.6%, or at least 0.8%, or at least 1%, or at least 1.5%, or at least 2%, or at least 2.5%, or at least 3%, or at least 3.5%, or at least 4%, or at least 4.5%, or at least 5% of the total number of the abrasive particles.

Embodiment 43. The abrasive article of embodiment 42, wherein the inverted portion is not greater than 20% of the total number of the abrasive particles or not greater than 18%, or not greater than 15%, or not greater than 12%, or not greater than 10%, or not greater than 9%, or not greater than 8%, or not greater than 7%, or not greater than 6%, or not greater than 5% of the total number of the abrasive particles.

Embodiment 44. The abrasive article of embodiment 27, further comprising a standing portion of abrasive particles (Pst) having a standing orientation and an inverted portion (Pi) of abrasive particles having an inverted orientation, and further comprising a ratio of the standing portion relative to the inverted portion (Pst/Pi) of at least 1, or at least 2.0, or at least 3.0, or at least 4.0, or at least 5.0, or at least 6, or at least 7, or at least 8, or at least 9, or at least 10, or at least 12, or at least 15, or at least 18, or at least 20, or at least 25, or at least 30, or at least 40, or at least 50.

Embodiment 45. The abrasive article of embodiment 44, wherein the ratio of the standing portion to the inverted portion (Pst/Pi) of not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6.

Embodiment 46. The abrasive article of embodiment 27, further comprising a slanted portion of abrasive particles (Psl) having a slanted orientation and an inverted portion (Pi) of abrasive particles having an inverted orientation, and further comprising a ratio of the slanted portion relative to the inverted portion (Psl/Pi) of at least 0.6, or at least 0.7, or at least 0.8, or at least 0.9, or at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0, or at least 5.2, or at least 5.4, or at least 5.6.

Embodiment 47. The abrasive article of embodiment 46, wherein the ratio of the slanted portion relative to the inverted portion (Psl/Pi) of not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6, or not greater than 4, or not greater than 3, or not greater than 2, or not greater than 1.5.

Embodiment 48. The abrasive article of embodiment 27, further comprising a fallen portion of abrasive particles (Pf) having a fallen orientation and an inverted portion (Pi) of abrasive particles having an inverted orientation, and further comprising a ratio of the fallen portion relative to the inverted portion (Pf/Pi) of at least 0.6, or at least 0.7, or at least 0.8, or at least 0.9, or at least 1, or at least 1.2, or at least 1.4, or at least 1.6, or at least 1.8, or at least 2.0, or at least 2.2, or at least 2.4, or at least 2.6, or at least 2.8, or at least 3.0, or at least 3.2, or at least or at least 3.4, or at least 3.6, or at least 3.8, or at least 4.0, or at least 4.2, or at least 4.4, or at least 4.6, or at least 4.8, or at least 5.0.

Embodiment 49. The abrasive article of embodiment 48, wherein the ratio of the fallen portion relative to the inverted portion (Pf/Pi) is not greater than 100, or not greater than 95, or not greater than 90, or not greater than 80, or not greater than 70, or not greater than 60, or not greater than 50, or not greater than 40, or not greater than 30, or not greater than 20, or not greater than 10, or not greater than 8, or not greater than 6, or not greater than 4, or not greater than 3, or not greater than 2, or not greater than 1.5.

Embodiment 50. The abrasive article of embodiment 27, further comprising a standing portion of abrasive particles (Pst) having a standing orientation and a slanted portion (Psl) of abrasive particles having a slanted orientation, and further comprising a well-oriented percentage represented by the sum of the standing portion (%) plus the slanted portion (%) relative to all of the abrasive particles (i.e., 100%), wherein the well-oriented percentage is at least 60%, or at least 62%, or at least 65%, or at least 67%, or at least 70%, or at least 72%, or at least 75%, or at least 77%, or at least 80%, or at least 82%, or at least 85%, or at least 87%, or at least 90%, or at least 92%, or at least 95%.

Embodiment 51. The abrasive article of embodiment 50, wherein the well-oriented percentage is not greater than 99.9%, or not greater than 99%, or not greater than 98%, or not greater than 97%, or not greater than 96%, or not greater than 95%.

Embodiment 52. A method of using an abrasive article comprising:
grinding a workpiece with the abrasive article in a particular grinding direction,
wherein the abrasive article comprises a backing:
an abrasive layer comprising abrasive particles and a binder;
wherein a first portion of the abrasive particles have a rotational orientation of 45-90 degrees relative to the grinding direction;
wherein a second portion of the abrasive particles have a rotational orientation of 0-45 degrees relative to the grinding direction.
wherein at least 10% of the first portion of the abrasive particles are fractured;
wherein no greater than 90% of the second portion of the abrasive particles are fractured.

Embodiment 53. The method of embodiment 52, wherein the abrasive article is the abrasive article of any one of embodiments 27 to 51.

Embodiment 54. The method of embodiment 52, wherein the abrasive particles comprise the abrasive particle of any one of embodiments 1 to 26.

Embodiment 55. The method of embodiment 52, wherein at least 20% of the first portion of the abrasive particles are fractured or at least 30%, or at least 40%, or at least 50%, or at least 60%, or at least 70%, or at least 80%, or at least 90% of the first portion of the abrasive particles are fractured.

Embodiment 56. The method of embodiment 52, wherein less than 99% of the first portion of the abrasive particles are fractured or less than 90%, or less than 80%, or less than 70%, or less than 60%, or less than 50%, or less than 40%, or less than 30%, or less than 20%, or less than 10% of the first portion of the abrasive particles are fractured.

Embodiment 57. The method of embodiment 52, wherein less than 80% of the second portion of the abrasive particles are fractured or less than 70%, or less than 60%, or less than 50%, or less than 40%, or less than 30%, or less than 20%, or less than 10% of the second portion of the abrasive particles are fractured.

Embodiment 58. The method of embodiment 52, wherein at least 10% of the first portion of the abrasive particles are fractured or at least 20%, or at least 30%, or at least 40%, or at least 50%, or at least 60%, or at least 70%, or at least 80%, or at least 90% of the second portion of the abrasive particles are fractured.

Embodiment 59. The abrasive particle of embodiment 1, wherein the fracture feature has a radius of curvature of at least 100 microns or at least 110 microns or at least 120 microns or at least 130 microns or at least 140 microns or at least 150 microns or at least 160 microns or at least 170 microns or at least 180 microns or at least 190 microns or at least 200 microns or at least 210 microns or at least 220 microns or at least 230 microns or at least 240 microns or at least 250 microns or at least 260 microns or at least 270 microns or at least 280 microns or at least 290 microns or at least 300 microns or at least 310 microns or at least 320 microns or at least 330 microns or at least 340 microns or at least 350 microns or at least 360 microns or at least 370 microns or at least 380 microns or at least 390 microns or at least 400 microns or at least 410 microns or at least 420 microns or at least 430 microns or at least 440 microns or at least 450 microns or at least 460 microns or at least 470 microns or at least 480 microns.

Embodiment 60. The abrasive particle of embodiment 1, wherein the fracture feature has a radius of curvature of not greater than 3000 microns or not greater than 2500 microns or not greater than 2000 microns or not greater than 1900 microns or not greater than 1800 microns or not greater than 1700 microns or not greater than 1600 microns or not greater than 1500 microns or not greater than 1400 microns or not greater than 1300 microns or not greater than 1200 microns or not greater than 1100 microns or not greater than 1000 microns or not greater than 900 microns or not greater than 800 microns or not greater than 700 microns or not greater than 600 microns or not greater than 500 microns.

Embodiment 61. The abrasive particle of embodiment 1, wherein the fracture feature has an indentation radius of curvature of at least 5 microns at least 10 microns at least 15 microns or at least 20 microns or at least 25 microns or at least 30 microns or at least 35 microns or at least 40 microns or at least 45 microns or at least 50 microns.

Embodiment 62. The abrasive particle of embodiment 1, wherein the fracture feature has an indentation radius of curvature of not greater than 100 microns or not greater than 90 microns or not greater than 80 microns or not greater than 70 microns or not greater than 60 microns or not greater than 50 microns or not greater than 40 microns or not greater than 30 microns or not greater than 20 microns.

### EXAMPLES

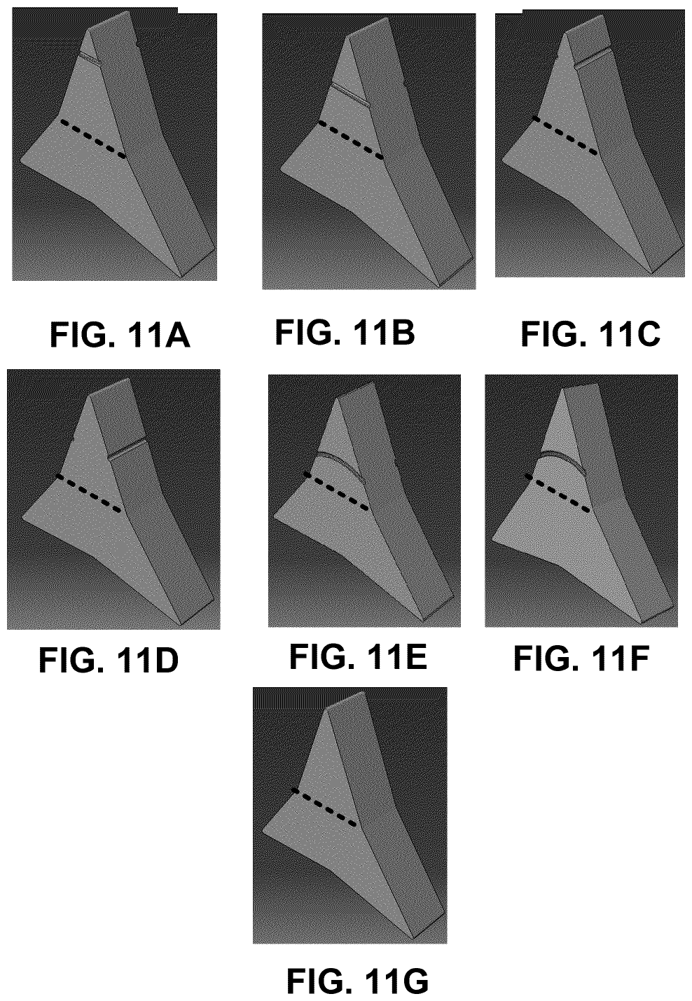

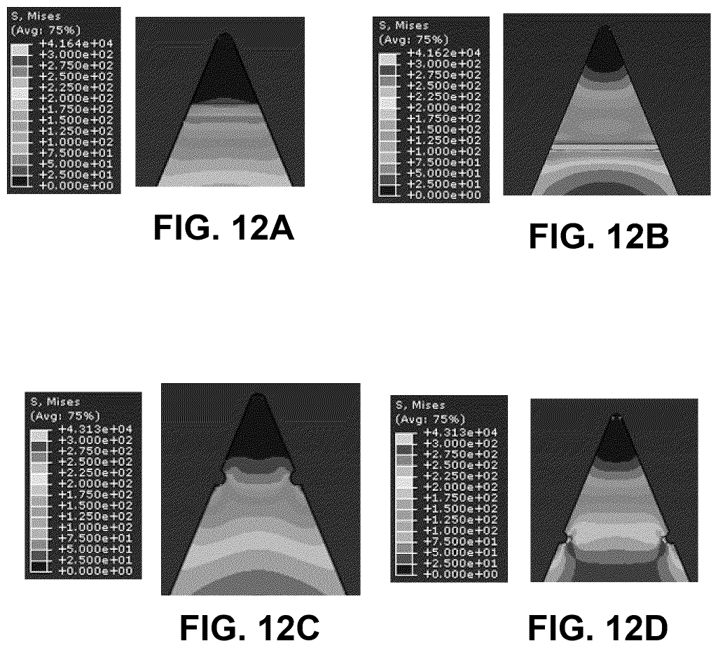

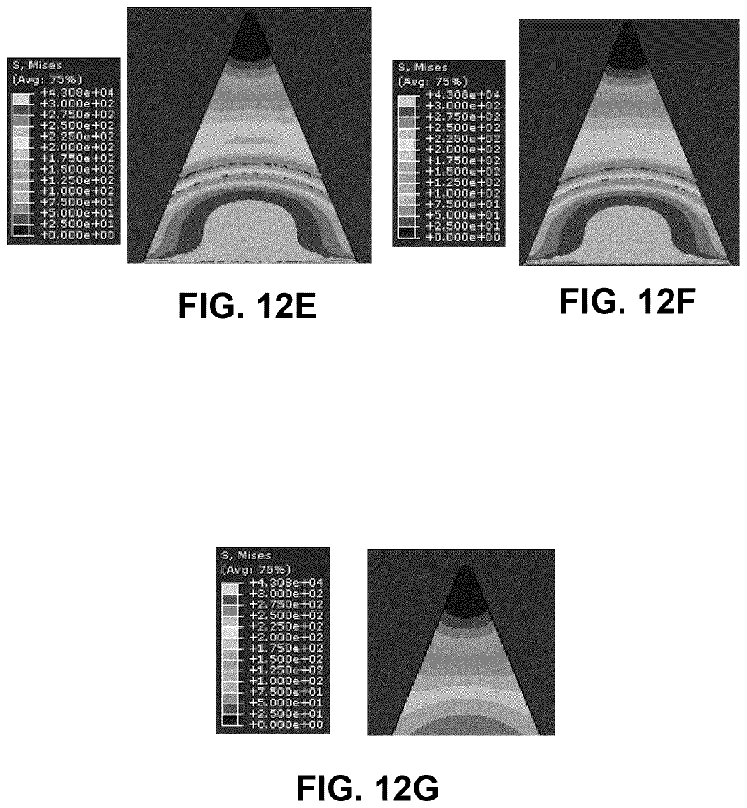

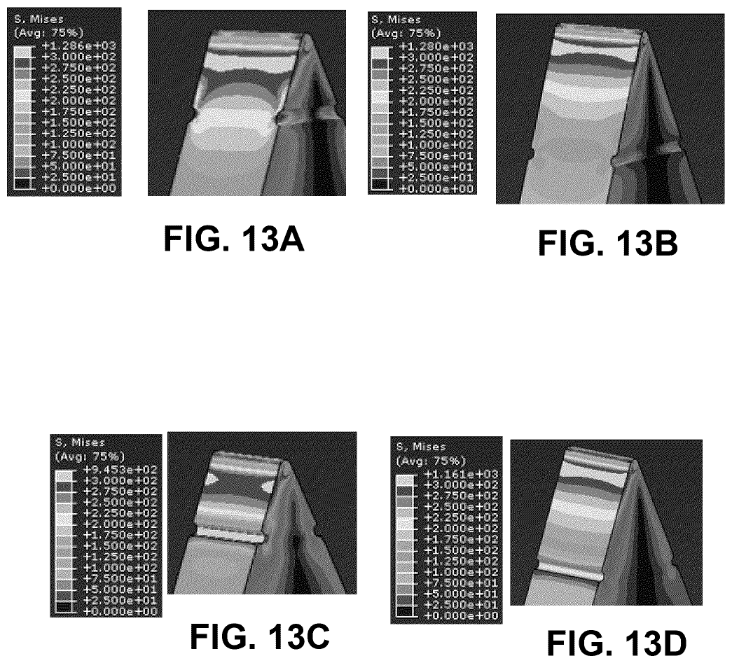

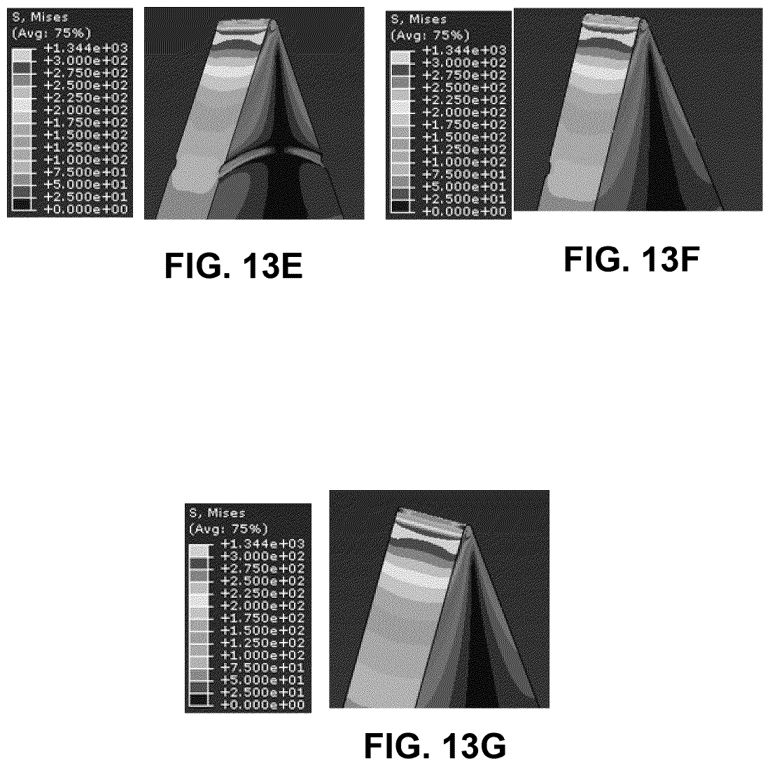

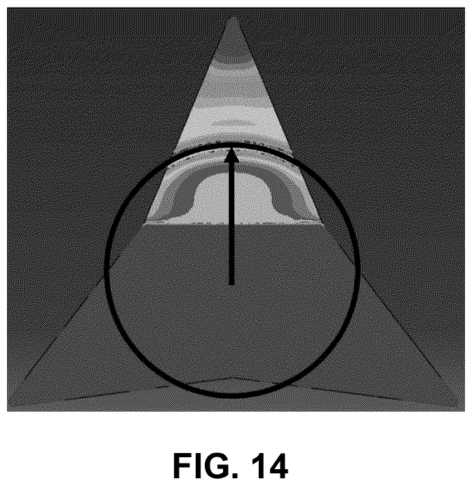

Abrasive particles S1, S2, S3, S4, S5, S6 and CS1 as shown in FIGS. 11A-G respectively, having the features in Table 1, had von Mises stresses measured via finite element analysis (FEA) software in different scenarios simulating front facing orientation grinding and side facing orientation grinding. Particles S1 and S2 had fracture features on the major or front surfaces. Particles S3 and S4 had fracture features on side surfaces. Particle S5 had curved fracture features on both major surfaces or front surfaces. Particle S6 had a single curved fracture feature on the major or front surface of the body. The radius of curvature for Particle S5 and S6 was determined by superimposing a best fit circle to the curvature of the fracture feature and determining the radius of the best fit circle using ImageJ to accurately measure the best fit circle as can be seen in FIG. 14. The radius of curvature for the fracture features of S5 and S6 was 470 microns. All particles S1-S6 had fracture features defined by semicircular indentations having an indentation radius of curvature of 15 microns. A boundary condition was set midway up the particle as shown in FIGS. 11A-G. To simulate front facing orientation grinding, a tension of 4.7 newtons and a normal force of 7.8 N was applied. To simulate side facing orientation grinding, a tension of 1.35 newtons and a normal force of 1.5 N was applied. The forces selected reflect the forces particles experience in traditional working conditions. Images showing the resulting stresses while in front facing orientation can be found in FIGS. 12A-G, while results for side facing orientation can be found in FIGS. 13A-G.

TABLE 1

| | | | | Front | | Side |
|---|---|---|---|---|---|---|
| | | | | Orientation | | Orientation |
| | Fracture | Fracture | Front | Results | Side | Results |
| | feature | feature | Orientation | relative to | Orientation | relative to |
| Particle | surface | height | results | CS1 | results | CS1 |
| S1 | Front | 0.95 H | FIG. 12A | No effect | FIG. 13A | Expedited |
| (FIG. 11A) | | | | relative to | | fracturing |
| | | | | CS1 | | relative to |
| | | | | | | CS1 |
| S2 | Front | 0.75 H | FIG. 12B | Expedited | FIG. 13B | No effect |
| (FIG. 11B) | | | | fracturing | | relative to |
| | | | | relative to | | CS1 |
| | | | | CS1 | | |
| S3 | Side | 0.95 H | FIG. 12C | Expedited | FIG. 13C | Expedited |
| (FIG. 11C) | | | | fracturing | | fracturing |
| | | | | relative to | | relative to |
| | | | | CS1 | | CS1 |
| S4 | Side | 0.75 H | FIG. 12D | Expedited | FIG. 13D | No effect |
| (FIG. 11D) | | | | fracturing | | relative to |
| | | | | relative to | | CS1 |
| | | | | CS1 | | |
| S5 | Front | 0.75 H | FIG. 12E | Expedited | FIG. 13E | No effect |
| (FIG. 11E) | | | | fracturing | | relative to |
| | | | | relative to | | CS1 |
| | | | | CS1 | | |
| S6 | Front | 0.75 H | FIG. 12F | Expedited | FIG. 13F | No effect |
| (FIG. 11F) | | | | fracturing | | relative to |
| | | | | relative to | | CS1 |
| | | | | CS1 | | |
| Ideal | N/A | N/A | N/A | Expedited | N/A | No effect |
| | | | | fracturing | | or less |
| | | | | relative to | | fracturing |
| | | | | CS1 | | relative to |
| | | | | | | CS1 |
| CS1 | None | None | FIG. 12G | N/A | FIG. 13G | N/A |
| (FIG. 11G) | | | | | | |

In order to minimize grinding energy over continued use, particles desirably would experience expedited fracturing while used in front facing orientation grinding without experiencing expedited fracturing while used in side facing orientation grinding.

The present application represents a departure from the state of the art. While certain publications have disclosed that it is desirable to orient shaped abrasive particles in certain orientations these publications have not enabled the degree of orientation as disclosed in the present application. Notably, it is apparent that conventional coated abrasives have a significant portion of abrasive particles placed in undesirable orientations. The industry continues to desire an enabled system and method for achieving a greater degree of control of the orientation of abrasive particles in coated abrasives. The system and methods disclosed herein enable the formation of a coated abrasive articles having greater control over the orientation of particles on a backing for creation of coated abrasive articles. Moreover, the systems and methods herein may facilitate improved fine-tuned control over certain orientations, such as control over standing, slanted, fallen, and inverse orientations of grains.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure.

This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. An abrasive particle comprising:
a first major surface,
a second major surface,
a side surface between the first major surface and the second major surface,
a total height, H,
and at least one fracture feature located at a height of 55%-90% H.

2. The abrasive particle of claim 1, wherein the at least one fracture feature is located on the first major surface.

3. The abrasive particle of claim 1, wherein the abrasive particle comprises at least one fracture feature on the first major surface and at least 1 fracture feature on the second major surface.

4. The abrasive particle of claim 1, wherein the at least one fracture feature is on a side surface.

5. The abrasive particle of claim 1, wherein at least two fracture features are located on different side surfaces.

6. The abrasive particle of claim 1, wherein the fracture feature is a semicircular indentation in a surface of the abrasive particle.

7. The abrasive particle of claim 1, wherein the abrasive particle is a shaped or elongated particle having a length (1), a width (w) and a thickness (t), wherein the width>thickness and the length>thickness.

8. The abrasive particle of claim 1, wherein the fracture feature comprises a radius of curvature of at least 100 microns and not greater than 3000 microns.

9. An abrasive article comprising:
a backing:
an abrasive layer comprising abrasive particles and a binder;
wherein the abrasive particles comprise a random rotational orientation;
wherein the abrasive particles comprise a total height, H, and a fracture feature located at a height of 55%-90% H.

10. The abrasive article of claim 9, further comprising a standing portion of abrasive particles having a standing orientation, wherein the standing portion includes at least 10% of the total number of the abrasive particles.

11. The abrasive article of claim 9, further comprising a standing portion of abrasive particles (Pst) having a standing orientation and a slanted portion (Psl) of abrasive particles having a slanted orientation, and further comprising a well-oriented percentage represented by the sum of the standing portion (%) plus the slanted portion (%) relative to all of the abrasive particles (i.e., 100%), wherein the well-oriented percentage is at least 60%.

12. The abrasive article of claim 9, wherein the well-oriented percentage is not greater than 99.9%, or not greater than 99%, or not greater than 98%, or not greater than 97%, or not greater than 96%, or not greater than 95%.

13. The abrasive article of claim 9, wherein the abrasive particles are shaped or elongated particles having a length (l), a width (w) and a thickness (t), wherein the width>thickness and the length>thickness.

14. The abrasive article of claim 9, wherein the fracture feature comprises a radius of curvature of at least 100 microns and not greater than 3000 microns.

15. The abrasive article of claim 9, further comprising a fallen portion of abrasive particles having a fallen orientation, wherein the fallen portion includes not greater than 20% of the total number of the abrasive particles.

16. A method of using an abrasive article comprising:
grinding a workpiece with the abrasive article in a particular grinding direction,
wherein the abrasive article comprises a backing:
an abrasive layer comprising abrasive particles and a binder;
wherein a first portion of the abrasive particles have a rotational orientation of 45-90 degrees relative to the grinding direction;
wherein a second portion of the abrasive particles have a rotational orientation of 0-45 degrees relative to the grinding direction;
wherein at least 10% of the first portion of the abrasive particles are fractured;
wherein no greater than 90% of the second portion of the abrasive particles are fractured.

17. The method of claim 16, wherein the abrasive article is the abrasive article of claim 9.

18. The method of claim 16, wherein the abrasive particles comprise the abrasive claim 1.

19. The method of claim 16, wherein at least 20% of the first portion of the abrasive particles are fractured.

20. The method of claim 16, wherein less than 80% of the second portion of the abrasive particles are fractured.
